(19) United States
(12) Patent Application Publication
(10) Pub. No.: US 2026/0168557 A1
(43) Pub. Date: Jun. 18, 2026

(54) Hydraulic Suspension Dampers with Control Valve Assembly and Regulating Controls

(71) Applicant: Roy A. Turner, Victorville, CA (US)

(72) Inventor: Roy A. Turner, Victorville, CA (US)

(21) Appl. No.: 19/213,816

(22) Filed: May 20, 2025

Related U.S. Application Data
(60) Provisional application No. 63/733,227, filed on Dec. 12, 2024.

(51) Int. Cl. F16F 9/346; F16F 9/06; F16F 9/44

(52) U.S. Cl. CPC F16F 9/346; F16F 9/062; F16F 9/063; F16F 9/446; F16F 2222/126; F16F 2230/42; F16F 2238/026

(57) ABSTRACT

A suspension damper includes a housing bounding a primary chamber with a main piston having a compression port extending therethrough disposed within the primary chamber. A control valve assembly is disposed within the primary chamber adjacent to the main piston, The control valve assembly includes a valve guide and a control valve with one at least partially encircling the other so that a valve compartment bound therebetween, the valve compartment being sealed from hydraulic fluid in the primary chamber with a gas being disposed within the valve compartment. The control valve assembly is movable between a first position where the control valve is positioned toward the main piston and a second position wherein the control valve is moved away from the main piston. A regulating spring extends between the main piston and the control valve, the regulating spring applying a resilient urging force against the control valve.

### CROSS-REFERENCE TO RELATED APPLICATIONS

This application claims the benefit of Provisional Application No. 63/733,227, filed Dec. 12, 2024, which is incorporation herewith.

### BACKGROUND OF THE DISCLOSURE

### 1. the Field of the Disclosure

The present disclosure relates to adjustable suspension dampers that can be used independently or as part of a shock absorber, front fork or other suspension system.

### 2. the Relevant Technology

Dampers are used in conventional shock absorbers, front forks, and other suspension systems to dampen or absorb an impact or force applied to the suspension system. For example, a conventional damper includes a tubular housing bounding a sealed chamber. An incompressible hydraulic fluid is disposed within the chamber of the housing. One end of a piston rod having a piston mounted thereon is also disposed within the chamber. Orifices extend through the piston so that the piston can slide within the chamber of the housing as the hydraulic fluid passes through the orifices.

When a compressive force is applied to the damper, such as when an automobile having shock absorbers hits a bump, the force seeks to drive the piston rod into the chamber of the housing. The damper partially absorbs this force by using the force to compress the hydraulic fluid through orifices. When a rebound force is applied to the damper, such as through the application of a spring, the damper again regulates the rebound force by requiring the hydraulic fluid to pass back through the orifices in the piston in order for the piston rod to return to its original position.

Although conventional dampers impart some degree of damping to suspension systems, conventional dampers have significant shortcomings. For example, the damping properties of conventional dampers are directly related to the constant restriction of the hydraulic fluid flow through the orifices extending through the piston. As this variable does not change along the stroke of the piston rod, the damping properties are substantially constant independent of the force applied or the position of the piston rod. As a result, minimum damping performance is achieved. What is needed in the art are dampers for suspension systems that can automatically adjust the damping characteristics throughout the range of piston movement to more efficiently dampen based on changing operating and road conditions. In addition, what is needed in the art are dampers that can be selectively adjusted by an operator to regulating damping properties during the compression stroke of the piston rod and/or the rebound stroke of the piston rod so that damping can be adjusted based on personal preferences and/or operating conditions. Furthermore, what is needed in the art are dampers that further minimize the initial impact force on the piston rod so as to help minimize pressure spikes within the damper and provide a smoother ride.

Although attempts have been made to produce adjustable dampers, such dampers are often difficult and expensive to produce and permit minimal selective adjustment based on use and condition requirements.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a cross sectional sideview of a suspension damper ready for a compression stroke;

FIG. 2 is an enlarged view of the boundary and piston rod assembly shown in FIG. 1;

FIG. 2A is a perspective view of the control plate used in the boundary check valve shown in FIG. 2;

FIG. 3 is an enlarged view of the boundary and piston rod assembly shown in FIG. 1;

FIG. 4A is an exploded rear perspective view of the piston rod assembly shown in FIG. 1;

FIG. 4B is an exploded front perspective view of the piston rod assembly shown in FIG. 4A;

FIG. 5 is a cross sectional sideview of the damper shown in FIG. 1 with the piston rod assembly moving distally along a compression stroke;

FIG. 6 is a cross sectional sideview of the damper shown in FIG. 5 with the piston rod assembly at the end of the compression stroke;

FIG. 7 is a cross sectional sideview of a portion the damper shown in FIG. 6 with the piston rod assembly starting a rebound stroke;

FIG. 8 is a cross sectional sideview of the damper shown in FIG. 6 with the piston rod assembly moving proximally along a rebound stroke;

FIG. 9 is a cross-sectional side view of an alternative embodiment of the suspension damper shown in FIG. 1;

FIG. 10 is a cross-sectional side view of another alternative embodiment of the suspension damper shown in FIG. 1;

FIG. 11 is an enlarged cross sectional side view of the distal end of the suspension damper shown in FIG. 10;

FIG. 12 is a rear perspective view of a subassembly of the suspension damper shown in FIG. 11;

FIG. 13 is a front perspective view of the subassembly shown in FIG. 12;

FIG. 14 is partially exploded front perspective view of the subassembly shown in FIG. 13;

FIG. 15 is partially exploded perspective view of a portion of the subassembly shown in FIG. 14;

FIG. 16 is partially exploded rear perspective view of the subassembly shown in FIG. 13;

FIG. 17 is a partially exploded perspective view of the rack assembly shown in FIG. 16;

FIG. 18 is a cross-sectional side view of the distal end of the suspension damper shown in FIG. 11 in a sprint mode;

FIG. 19 is a cross-sectional side view of the distal end of the suspension damper shown in FIG. 18 in a compression mode;

FIG. 20A is a cross-sectional side view of a distal end of the damper shown in FIG. 10;

FIG. 20B is a cross-sectional side view of the damper shown in FIG. 20A with the inner knob, outer knob, collar, and pinion assembly removed therefrom;

FIG. 20C is a cross-sectional side view of the damper shown in FIG. 20B having a gas delivery stem mounted on the end wall;

FIG. 21 is a perspective view of a shock absorber that includes an alternative embodiment of a piggy back damper;

FIG. 22 is a cross-sectional view of the damper shown in FIG. 21 taken along a first plane;

FIG. 23 is a cross-sectional view of the damper shown in FIG. 21 taken along a second plane;

FIG. 24 is front exploded view of an insert assembly of the damper shown in FIG. 23;

FIG. 25 is a rear exploded view of the insert assembly shown in FIG. 24;

FIG. 26 is a cross-sectional view of the damper shown in FIG. 21 taken along a third plane;

FIG. 27 is a perspective view of a regulating valve of the damper shown in FIG. 26; and

FIG. 28 is a perspective view of a sub-assembly of a secondary housing of the damper shown in FIG. 26.

### DETAILED DESCRIPTION OF THE PREFERRED EMBODIMENTS

Before describing the present disclosure in detail, it is to be understood that this disclosure is not limited to particularly exemplified apparatus, systems, assemblies, methods, or process parameters that may, of course, vary. It is also to be understood that the terminology used herein is only for the purpose of describing particular exemplary embodiments of the present disclosure and is not intended to limit the scope of the disclosure in any manner.

All publications, patents, and patent applications cited herein, whether supra or infra, are hereby incorporated by reference in their entirety to the same extent as if each individual publication, patent, or patent application was specifically and individually indicated to be incorporated by reference.

The term “comprising” which is synonymous with “including,” “containing,” or “characterized by,” is inclusive or open-ended and does not exclude additional, unrecited elements or method steps.

It will be noted that, as used in this specification and the appended claims, the singular forms “a,” “an” and “the” include plural referents unless the content clearly dictates otherwise. Thus, for example, reference to a “port” includes one, two, or more ports.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure or claims.

Where possible, like numbering of elements have been used in various figures. Furthermore, multiple instances of an element and or sub-elements of a parent element may each include separate letters appended to the element number. For example, two instances of a particular element “10” may be labeled as “10A” and “10B”. In that case, the element label may be used without an appended letter (e.g., “10”) to generally refer to all instances of the element or any one of the elements. Element labels including an appended letter (e.g., “10A”) can be used to refer to a specific instance of the element or to distinguish or draw attention to multiple uses of the element. Furthermore, an element label with an appended letter can be used to designate an alternative design, structure, function, implementation, and/or embodiment of an element. For example, two alternative exemplary embodiments of a particular element may be labeled as “10A” and “10B”. In that case, the element label may be used without an appended letter (e.g., “10”) to generally refer to all instances of the alternative embodiments or any one of the alternative embodiments.

Various aspects of the present devices and assemblies may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements present. Furthermore, as used herein, the terms “connection,” “connected,” and the like do not necessarily imply direct contact between the two or more elements.

Various aspects of the present devices, assemblies, and methods may be illustrated with reference to one or more exemplary embodiments. As used herein, the terms “embodiment,” “alternative embodiment” and “exemplary embodiment” mean “serving as an example, instance, or illustration,” and should not necessarily be construed as required or as preferred or advantageous over other embodiments disclosed herein.

Unless defined otherwise, all technical and scientific terms used herein have the same meaning as commonly understood by one of ordinary skill in the art to which the present disclosure pertains. Although a number of methods and materials similar to or equivalent to those described herein can be used in the practice of the present disclosure, the preferred materials and methods are described herein.

The present disclosure relates to hydraulic dampers that can be used independently or as part of a shock absorber, front fork or other suspension system. Such dampers can be used in association with all types of vehicles or mechanical apparatus where it is desired to control suspension movement and/or vibration. Examples of vehicles on which the dampers can be used include bicycles, motorcycles, automobiles, all-terrain vehicles (ATVs), snowmobiles, airplanes, and the like. The hydraulic dampers can also be used on various stationary mechanical apparatus where it is needed to control suspension movement and/or vibration.

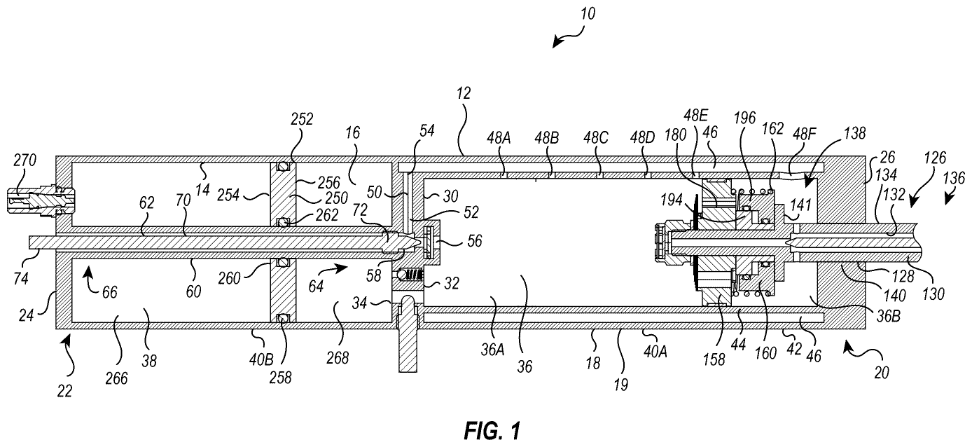

Depicted in FIG. 1 is one embodiment of a suspension damper 10 incorporating features of the present disclosure. Damper 10 comprises a housing 12 having an interior surface 14 bounding a chamber 16. Housing 12 comprises a cylindrical sidewall 18 having an exterior surface 19 that extends between a proximal end 20 and an opposing distal end 22. A distal end wall 24 is disposed at distal end 22 of sidewall 18 while a proximal end wall 26 is disposed at proximal end 20 of sidewall 18. In one embodiment, distal end wall 24 and/or proximal end wall 26 can be removably mounted on sidewall 18 such as by threaded engagement or other form of releasable engagement.

Housing 12 also includes a boundary 30 radially inwardly projecting from interior surface 14 of sidewall 18 so as to laterally span across chamber 16. Boundary 30 is spaced apart from but is located between proximal end wall 26 and distal end wall 24. Boundary 30 has a first side face 32 that faces proximal end wall 26 and an opposing second side face 34 that faces distal end wall 24. In one embodiment, boundary 30 can be centrally disposed along the length of sidewall 18 or can be located closer toward distal end wall 24 or proximal end wall 26. Boundary 30 divides chamber 16 into a primary chamber 36 extending between boundary 30 and proximal end wall 26 and a secondary chamber 38 extending between boundary 30 and distal end wall 24.

In the depicted embodiment, sidewall 18 comprises a primary sidewall portion 40A extending between proximal end wall 26 and boundary 30 and a secondary sidewall portion 40B extending between boundary 30 and distal end wall 24. Primary sidewall portion 40A comprises an outer sidewall 42 and an inner sidewall 44. Outer sidewall 42 and inner sidewall 44 can both encircle primary chamber 36 and can each typically have a cylindrical configuration that extends between proximal end wall 26 and boundary 30. Inner sidewall 44 is radially inwardly spaced apart from outer sidewall 42 and is typically concentrically disposed within outer sidewall 42. A bypass channel 46 is disposed between inner sidewall 44 and outer sidewall 42 and typically has a cylindrical configuration so as to encircle primary chamber 36 and thus at least a portion of chamber 16/primary chamber 36. In an alternative embodiment, bypass channel 46 need not entirely encircle primary chamber 36. For example, inner sidewall 44 can be configured so that bypass channel 46 only extends partially around primary chamber 36. In addition, in one embodiment bypass channel 46 extends from boundary 30 to proximal end wall 26. However, in alternative embodiments, bypass channel 46 need not extend to boundary 30 and/or to proximal end wall 26. For example, inner sidewall 44 can terminate short of boundary 30 and/or proximal end wall 26.

A plurality of ports 48A-48F pass through inner sidewall 44 so as to provide fluid communication between primary chamber 36 and bypass channel 46. Ports 48A-48F are longitudinally spaced apart along inner sidewall 44 in sequential order with port 48A disposed toward boundary 30 and port 48F disposed toward proximal end wall 26. In the depicted embodiment, six ports 48A-48F are shown. In alternative embodiments, other numbers of ports 48 can be used. For example, ports 48 can comprise at least 2, 4, 6, 8, or 10 ports or in a range between any two of the forgoing. Other numbers can also be used. Ports 48 typically have a diameter of at least or less than 0.5 mm, 1 mm, 1.5 mm, 2 mm, 3 mm, 4 mm, or 5 mm or are in a range between any two of the foregoing. Other diameters can also be used depending on application.

Continuing with FIG. 1, a transfer passage 50 is formed within boundary 30 having a first end 52 that is generally centrally disposed on boundary 30 and an opposing second end 54 that communicates with bypass channel 46. Boundary 30 also includes an inlet passage 56 that extends from first side face 32 of boundary 30 to first end 52 of transfer passage 50. A control passage 58 is aligned with or otherwise communicates with inlet passage 56 and extends from second side face 34 of boundary 30 to first end 52 of transfer passage 50. A tubular stem 60 is disposed within secondary chamber 38 and bounds an access passage 62 extending between a first end 64 and an opposing second end 66. First end 64 is disposed on second side face 34 of boundary 30 so that access passage 62 is aligned with and communicates with control passage 58 and inlet passage 56. Second end 66 extends to distal end wall 24 and can pass therethrough. Access passage 62 extends through distal end wall 24. Tubular stem 60 can be permanently fixed to or removably coupled to boundary 30 and/or distal end wall 24. For example, tubular stem 60 can be welded to, integrally formed with, press fit onto, or threadedly coupled with boundary 30 and/or distal end wall 24.

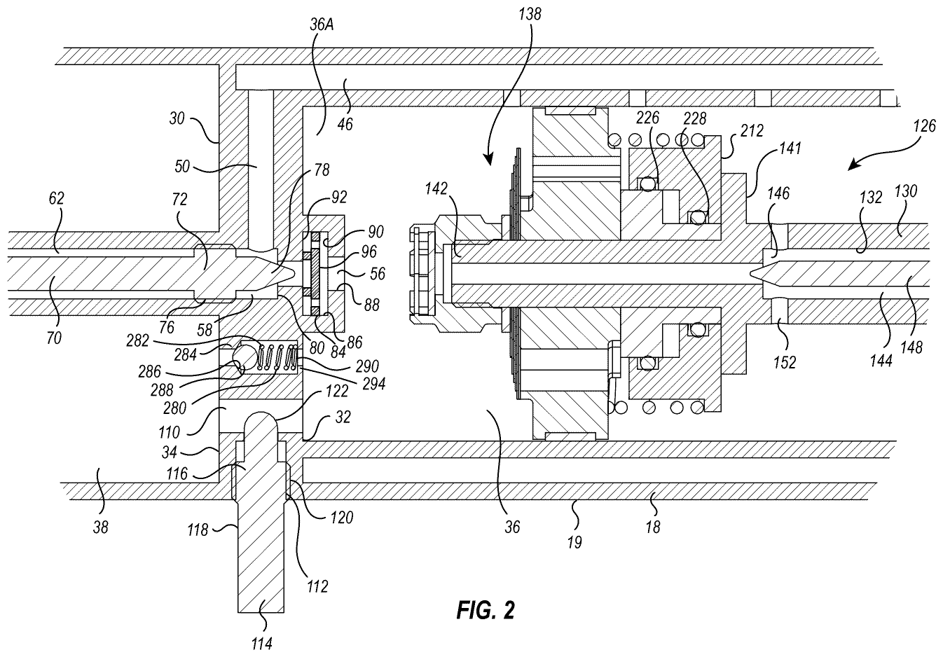

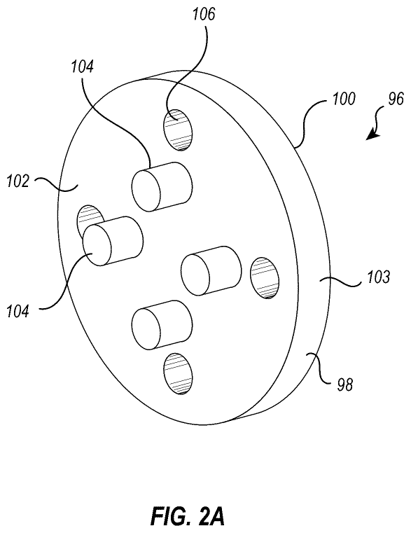

A compression metering needle 70 is disposed within access passage 62 of tubular stem 60 and extends between a first end 72 and an opposing second end 74. Second end 74 freely projects out through access passage 62 so as to allow manual rotation of compression metering needle 70 to adjust the position thereof. For example, turning to FIG. 2, first end 72 of regulating needle has threads 76 that threadedly engage with stem 60 and/or boundary 30 so that rotation of compression metering needle 70 results in advancing or retracing compression metering needle 70 within access passage 62. First end 72 terminates at a tapered tip 78 that extends through control passage 58 and to inlet passage 56. Advancing compression metering needle 70 advances tip 78 into inlet passage 56 so as to progressively constrict inlet passage 56 until tip 78 sits against a mouth 80 encircling inlet passage 56 and thereby seals or substantially seals inlet passage 56 closed. Retracting compression metering needle 70 progressively withdraws tip 78 from within inlet passage 56, thereby progressively opening inlet passage 56 so as to allow greater fluid flow therethrough, as will be discussed below in greater detail. Accordingly, adjusting the position of compression metering needle 70 can adjust flow rate of fluid between transfer passage 50 and inlet passage 56.

Fluid flow through inlet passage 56 is also controlled by a check valve 84 associated with inlet passage 56. Check valve 84 comprises an annular groove 86 recessed into an interior surface 88 of boundary 30 bounding inlet passage 56 so as to encircle inlet passage 56. Groove 86 is bounded between a front face 90 and an opposing back face 92. Movably disposed within groove 86 so as to extend across inlet passage 56 is a control plate 96. As shown in FIG. 2A, control plate 96 comprises a plate body 98 having a top face 100 and an opposing bottom face 102 that each extend toward an outer perimeter edge 103. Outwardly projecting from bottom face 102 at locations toward perimeter edge 103 are a plurality of spaced apart legs 104. A plurality of openings 106 extend through plate body 98 from top face 100 to bottom face 102 at locations toward perimeter edge 103.

With reference to FIGS. 2 and 2A, control plate 96 is disposed within groove 86 and is movable between an open position and a closed position. Specifically, as discussed below in more detail, in one method of use fluid is forced to flow from primary chamber 36 into inlet passage 56. In so doing, the fluid moves control plate 96 laterally to the open position, as shown in FIG. 2, so that legs 104 are seated against back face 92 of groove 86 but bottom face 102 and top face 100 are spaced apart from back face 92 and front face 90 of groove 86, respectively. In this position, fluid can freely flow from primary chamber 36 into inlet passage 56, through openings 106 in control plate 96/plate body 98, around tip 78 of compression metering needle 70, into transfer passage 50, and finally into bypass channel 46. Adjusting the position of compression metering needle 70, as discussed above, can be used to regulate the flow rate of the fluid passing from primary chamber 36 to bypass channel 46.

In another method of operation, as discussed below, fluid can seek to flow in the opposite direction from bypass channel 46 to transfer passage 50, around tip 78 of compression metering needle 70, through inlet passage 56, and into primary chamber 36. In so doing, however, the fluid moves control plate 96 laterally to the closed position wherein top face 100 of control plate 96 is now seated directly against front face 90 of groove 86 so that openings 106 are covered by front face 90, thereby precluding or limiting fluid from flowing through openings 106 and along inlet passage 56 into primary chamber 36. As such, control plate 96 and groove 86 function to operate as check valve 84 that only lets fluid freely flow through inlet passage 56 in one direction. It is appreciated that check valve 84 can have a variety of other configurations that perform the same function. For example, check valve 84 can comprise a ball and spring check valve, a flexible shim valve, as discussed below, a spring-loaded flapper valve, or other automatic check valves. However, the disclosed embodiment has a number of benefits in that it is simply in design and production, occupies minimal space, and is efficient in operation.

As also shown in FIG. 2, a pressure control passage 110 extends through boundary 30 from first side face 32 to second side face 34. A bore 112 extends from an exterior surface 19 of sidewall 18, along a portion of boundary 30, and converges with pressure control passage 110. A regulating needle 114 has a first end 116 disposed within bore 112 and an opposing second end 118 that freely projects outside of sidewall 18 or is otherwise accessible from outside of sidewall 18. Regulating needle 114 has threads 120 that threadedly engage with sidewall 18 and/or boundary 30 so that rotation of regulating needle 114 results in advancing or retracing regulating needle 114 within bore 112. First end 116 terminates at a tapered tip 122 that can project into pressure control passage 110. Tip 122 is typically rounded or otherwise tapered. Second end 118 is accessible from outside of sidewall 18 so that second end 118 can be selectively rotated by manually gripping second end 118 or engaging second end 118 with a tool. Advancing regulating needle 114 advances tip 122 into pressure control passage 110 so as to progressively and selectively constrict pressure control passage 110 and thereby restrict the flow of fluid between primary chamber 36 and secondary chamber 38. Retracting regulating needle 114 progressively withdraws tip 122 from within pressure control passage 110 to progressively and selectively open pressure control passage 110 and thereby allow greater fluid flow between primary chamber 36 and secondary chamber 38, as will be discussed below in greater detail. Accordingly, adjusting the position of regulating needle 114 can adjust a fluid flow rate through pressure control passage 110.

Turning to FIG. 2, a return passage 280 extends through boundary 30 between first side face 32 and second side face 34. A check valve 282 is associated with return passage 280 that allows fluid to flow from secondary chamber 38 to primary chamber 36 but restricts or precludes fluid from flowing from primary chamber 36 to secondary chamber 38. In the depicted embodiment, check valve 282 comprises a ball and spring check valve. Specifically, an annular shoulder 284 radially inwardly projects into return passage 280 adjacent to second side face 34 and forms an annular tapered seat 286 encircling return passage 280. A ball 288 is disposed within return passage 280 and is biased against seat 286 by a spring 290. An annular shoulder 294 radially inwardly projects into return passage 280 adjacent to first side face 34. Shoulder 294 forms a seat against which a back end of spring 290 rests so that spring 290 biases ball 288 against seat 286. In this configuration, ball 288 restricts or precludes fluid flow through return passage 280 from primary chamber 36 to secondary chamber 38. However, fluid can flow through return passage 280 from secondary chamber 38 to primary chamber 36 when the fluid pressure is sufficiently high within secondary chamber 38 to move ball 288 off of seat 286 by compressing spring 290. Shoulders 284 and/or 294 can be integrally formed with boundary 30 or can comprise a tubular bushing or other structure that is removably secured to or securely fixed to boundary 30. In alternative embodiments, check valve 282 can have other configurations, such as those discussed herein. For example, in one alternative embodiment a flexible shim can be mounted on first side face 32 so as to cover the opening to return passage 280 thereat. The flexible shim resiliently flexes outward to allow hydraulic fluid to flow proximally through return passage 280 but covers the opening to return passage 280 to prevent or restrict the hydraulic fluid from flowing distally through return passage 280.

Returning to FIG. 1, proximal end wall 26 has a passageway 128 centrally extending therethrough so as to communicate with chamber 16/primary chamber 36. A piston rod 130 is slidably disposed within passageway 128 so as to extend into and outside of chamber 16/primary chamber 36. Piston rod 130 has an interior surface 132 and an opposing exterior surface 134 extending between a proximal end 136 and an opposing distal end 138. An annular seal 140, such as an O-ring or packing, is disposed within an annular groove formed on an interior surface of passageway 128 so that annular seal 140 effects a dynamic seal between proximal end wall 26 and piston rod 130. The dynamic seal enables piston rod 130 to freely slide into and out of housing 12 while preventing fluid from flowing out of chamber 16/primary chamber 36.

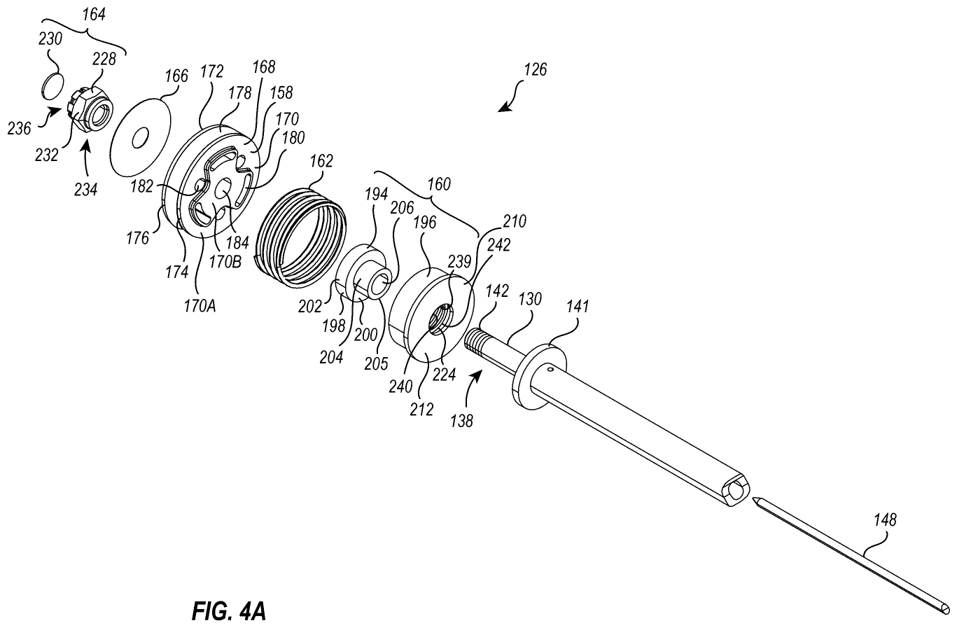

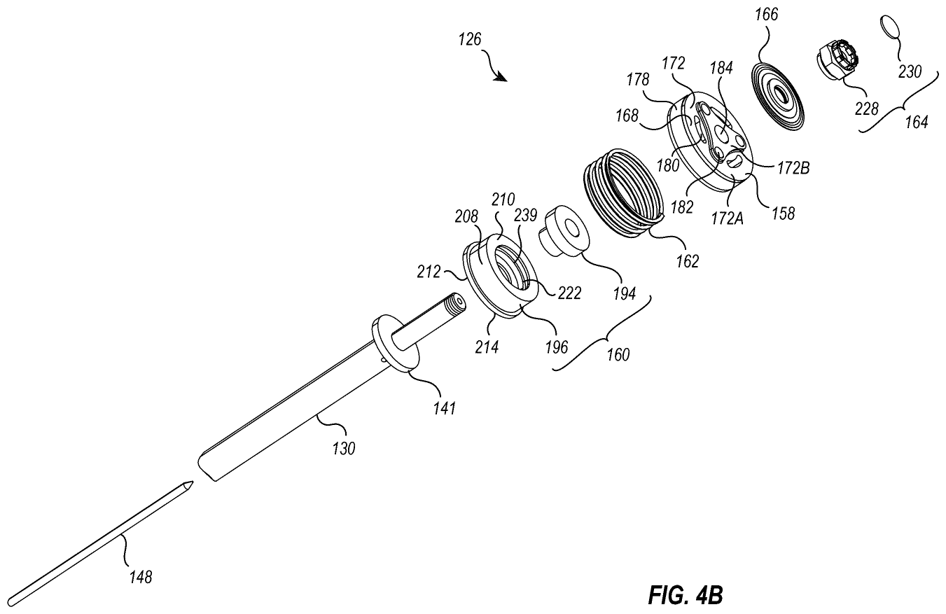

A flange 141 radially outwardly projects from exterior surface 134 of piston rod 130 at or toward distal end 138 and is disposed within chamber 16/primary chamber 36. Flange 141 can, as depicted in FIG. 4A, completely encircle piston rod 130 but need not do so. Flange 141 can be integrally formed with or separately mounted on piston rod 130.

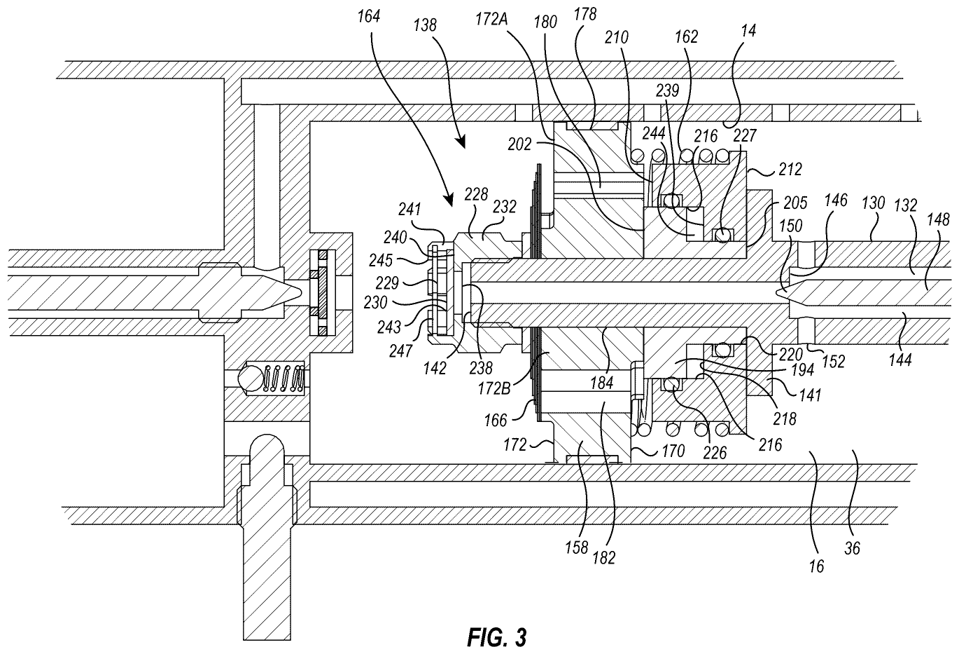

Turning to FIG. 3, distal end 138 of piston rod 130 terminates at a distal end face 142. Interior surface 132 of piston rod 130 bounds a channel 144 extending along the length of piston rod 130 and passing through distal end face 142. Piston rod 130 includes an annular shoulder 146 radially inwardly projecting into channel 144 at or toward distal end 138. A rebound metering needle 148 is at least partially disposed within channel 144 proximal of annular shoulder 146. Rebound metering needle 148 can be selectively advanced and retracted within channel 144. For example, rebound metering needle 148 can be threadedly engaged with piston rod 130 such that rotation of rebound metering needle 148, manually or with a tool, can facilitate advancing and retracting of rebound metering needle 148 within channel 144.

Rebound metering needle 148 terminates at a tip 150 that is typically tapered or is otherwise configured to sit against shoulder 146 to regulate or block fluid flow through channel 144. That is, rebound metering needle 148 can be advanced so that tip 150 directly seats against shoulder 146 so as to block fluid flow through channel 144 or rebound metering needle 148 can be retracted so that tip 150 is selectively spaced back from shoulder 146 to selectively control fluid flow through channel 144. One or more ports 152 can laterally pass through piston rod 130 so as to communicate with channel 144 proximal of shoulder 146. As will be discussed below in more detail, in this configuration, fluid can flow from primary chamber 36, through ports 152, distally along channel 144, and out distal end face 142. The rate of this flow can be controlled by the position of rebound metering needle 148.

As depicted in FIGS. 4A and 4B, damper 10 includes a piston rod assembly 126 that comprises piston rod 130 as discussed above. Mounted on distal end 138 of piston rod 130 is a main piston 158, a control valve assembly 160, a regulating spring 162 extending between main piston 158 and control valve assembly 160, an end valve 164, and a shim assembly 166 disposed between end valve 164 and main piston 158.

With reference to FIGS. 3, 4A and 4B, end valve 164 comprises a tubular valve body 228 having a check valve 229 disposed on a distal end thereof. Valve body 228 comprises a base 232 having a proximal end 234 and an opposing distal end 236 with an opening 238 extending therebetween. Distal end 236 terminates at a distal end face 240. Check valve 229 includes a plurality of spaced apart arms 241 that are disposed around opening 238 and that outwardly project distally from distal end 236 or distal end face 240 of base 232. Arms 241 bound a recess 243 in which a control plate 230 is movably disposed. Each arm 241 terminates at an inwardly projecting finger 245. A resiliently constrictable C-clip 247 is disposed within recess 243 against fingers 245 to reduce the diameter of recess 243. That is, with C-clip 247 removed, control plate 230 can be freely position within recess 243. Once C-clip 247 is positioned within recess 243, C-clip 247 blocks control plate 230 from passing out of recess 243. Valve body 228/end valve 164 is secured on distal end 138 of piston rod 130 such as by passing distal end face 142 of piston rod 130 into opening 238. Piston rod 130 and valve body 228 can be secured together by threaded connection, press fit connection, welding or other conventional connecting techniques.

Control plate 230 typically has a circular disk-shaped configuration and is movably captured within recess 246 by the plurality of arms 241 and C-clip 247. Specifically, as discussed in further detail below, depending on the movement direction of piston rod 130, control plate 230 moves along the longitudinal axis of piston rod 130 between either an open position, as shown in FIG. 2, where control plate 230 is disposed against and is restrained by fingers 245 of arms 241 and/or C-clip 247 or is in a closed position, as shown in FIG. 3, wherein control plate 230 is disposed against distal end face 240 of base 232. When control plate 230 is in the open position, fluid can freely flow from primary chamber 36, into ports 152, distally along channel 144, out through distal end face 142 of piston rod 130, through opening 238 of valve body 228, and finally back into primary chamber 36 by flowing out through the gaps between fingers 245. When control plate 230 is in the closed position, control plate 230 sits flush against distal end face 240 of base 232, thereby preventing fluid from flowing in the opposite direction. That is, fluid is precluded from flowing from primary chamber 36 directly into the distal opening of channel 144 because opening 238 of valve body 228 is closed by control plate 230. As such, control plate 230 with fingers 245 functions as check valve 299. In alternative embodiments, other configurations of check valves can be used to control the flow of fluid through piston rod 130. For example, check valve 299 can comprise a ball and spring check valve, a flexible shim valve, as discussed below, a spring-loaded flapper valve, or other automatic check valves.

With continued reference to FIGS. 3, 4A and 4B, main piston 158 has a substantially circular, disk shape body 168 configuration with a proximal face 170, an opposing distal face 172, and a peripheral side 174 extending therebetween. An annular groove 176 is formed on peripheral side 174 so as to encircle body 168. An annular seal 178 is disposed and secured within groove 176. Seal 178 slidably seals against interior surface 14 of sidewall 18 (FIG. 3) as piston rod 130 is advanced into and out of chamber 16/primary chamber 36. Seal 178 is typically comprised of Teflon but other sealing materials can be used. In one alternative embodiment, a flexible O-ring can be positioned on an interior surface of annular seal 178 so as to radially outwardly press seal 178 as disclosed in U.S. Pat. No. 6,978,872, which is incorporated herein by specific reference. Other conventional seal configurations and materials can also be used.

With continued reference to FIGS. 4A and 4B, proximal face 170 of main piston 158 further comprises a proximal lower face 170A and a proximal raised face 170B wherein proximal raised face 170B is outwardly spaced apart from proximal lower face 170A. Similarly, distal face 172 further comprises a distal lower face 172A and a distal raised face 172B wherein distal raised face 172B is outwardly spaced apart from distal lower face 172A. A plurality of spaced apart compression ports 180 extend through main piston 158 from distal lower face 172A to proximal raised face 170B. Compression ports 180 extend at a substantially constant radius from a center of main piston 158. Similarly, a plurality of rebound ports 182 extend through main piston 158 from distal raised face 172B to proximal lower face 170A. Rebound ports 182 can also extend at a substantially constant radius from a center of main piston 158. By using raised and lowered faces, compression ports 180 and rebound ports 182 can be positioned at substantially the same radius from the center of main piston 158 but still be selectively closed or blocked, as discussed below. This configuration enables the use of a smaller and simpler main piston. A central opening 184 also extends centrally though main piston 158 between proximal face 170 and distal face 172 and is configured to receive piston rod 130.

In the assembled state depicted in FIG. 3, piston rod 130 is passed through central opening 184 of main piston 158 so that main piston 158 encircles and radially outwardly projects from piston rod 130. Seal 178 is biased in sealed engagement against interior surface 14 of sidewall 18 so as to enable main piston 158 to freely slide within chamber 16/primary chamber 36 as piston rod 130 is moved within chamber 16/primary chamber 36.

In one embodiment of the present disclosure, means are provided for enabling fluid flow through rebound ports 182 from proximal face 170 to distal face 172 while precluding fluid flow through rebound ports 182 from distal face 172 to proximal face 170. By way of example and not by limitation, shim assembly 166 encircles piston rod 130 and bias against distal raised face 172B of main piston 158. As a result of distal raised face 172B being raised or offset from distal lower face 172A, shim assembly 166 covers the distal openings to rebound ports 182 but does not cover the distal openings to compression ports 180. Shim assembly 166 can comprise a single shim or a plurality of stacked shims. For example, FIG. 4B depicts shim assembly 166 as a plurality of flexible annular shims stacked together with each consecutive shim having a smaller outer diameter.

End valve 164, as discussed above, is secured on piston rod 130 so that shim assembly 166 is captured and securely held between end valve 164 and main piston 158. However, end valve 164 is configured so that the outer perimeter of shim assembly 166 can resiliently flex distally under fluid pressure. That is, fluid can travel in a distal direction through rebound ports 182 by resiliently flexing shim assembly 166, but fluid is precluded from traveling in a proximal direction through rebound ports 182 as a result of shim assembly 166 covering the distal opening to rebound ports 182. In general, the greater the fluid pressure acting against shim assembly 166 within rebound ports 182, the farther shim assembly 166 will flex and the more rebound ports 182 are opened. Shim assembly 166, acting in concert with end valve 164 and main piston 158, thus acts as a type of check valve during movement of piston rod 130.

In alternative embodiments of the means for enabling fluid flow through rebound ports 182, it is appreciated that shim assembly 166 can be replaced with any number of alternative check valve designs. For example, flexible shims can be replaced with a solid washer or hinged flaps that are biased against distal face 172 over rebound ports 182 by a spring. Other alternative designs are disclosed in U.S. Pat. No. 6,978,872, which was previously incorporated herein by specific reference.

With continued reference to FIGS. 4A and 4B, control valve assembly 160 comprises a valve guide 194 and a control valve 196. Valve guide 194 comprises an annular base 198 having a proximal face 200 and an opposing distal face 202. Projecting from proximal face 200 is an annular stem 204 terminating at a proximal end face 205. Stem 204 has an outer diameter smaller than an outer diameter of base 198. A central opening 206 extends through both stem 204 and base 198. In the assembled state depicted in FIG. 3, piston rod 130 is passed through central opening 206 so that distal face 202 of valve guide 194 rests against proximal face 170/proximal raised face 170B of main piston 158 and proximal end face 205 rests against flange 141. Thus, valve guide 194 is fixedly locked in place by being clamped between a flange 141 and main piston 158. In alternative embodiments, it is appreciated that valve guide 194 can be directly secured to or integrally formed with main piston 158.

Returning to FIGS. 4A and 4B, control valve 196 has an exterior peripheral side 208 that is annular and extends between an annular distal face 210 and an annular proximal face 212. Distal face 210 has a surface area smaller than a surface area of proximal face 212. In one embodiment, the aspect ratio of the surface area of distal face 210 to the surface area of proximal face 212 is in a range between about 0.3 to about 0.6 with about 0.3 to about 0.4 being more preferred. An annular flange 214 radially outwardly projects from peripheral side 208 at or adjacent to proximal face 212. Control valve 196 also comprises an interior surface 239 bounding a channel 242 that centrally extends through control valve 196 between distal face 210 and proximal face 212. As best depicted in FIG. 3, interior surface 239 comprises a cylindrical first surface portion 216 extending from distal face 210 to an annular radially inwardly projecting shoulder 218 and a cylindrical second surface portion 220 extending from shoulder 218 to proximal face 212. First surface portion 216 has an inner diameter larger than second surface portion 220. First surface portion 216 encircles a first channel portion 222 (FIG. 4B) while second surface portion 220 bounds a second channel portion 224 (FIG. 4A). Channel portions 222 and 224 combine to form the channel 242 centrally extending through control valve 196.

During assembly, control valve 196 is slidably mounted on valve guide 194 prior to mounting control valve 196 on piston rod 130, as discussed above. In the assembled state, as shown in FIG. 3, control valve 196 is positioned so that stem 204 of valve guide 194 is disposed within second channel portion 224, i.e., second surface portion 220 encircles stem 204, while base 198 of valve guide 194 is disposed in first channel portion 222, i.e., first surface portion 216 encircles base 198. An annular recessed groove is formed on first surface portion 216 in which a first seal 226 is disposed forming a dynamic fluid sealed engagement between first surface portion 216 and base 198. Similarly, an annular recessed groove is formed on second surface portion 220 in which a second seal 227 is disposed forming a dynamic fluid sealed engagement between second surface portion 220 and stem 204.

A valve compartment 244 is formed between control valve 196 and valve guide 194 and which is sealed closed by first seal 226 and second seal 227. Disposed within valve compartment 244 is a compressible gas, such as air. In one embodiment, as control valve 196 is received over valve guide 194, air is captured within valve compartment 244 at a first pressure, i.e., atmospheric pressure.

In the fully assembled state, as shown in FIG. 1, the distal end of piston rod 130 is movably disposed within primary chamber 36 with control valve assembly 160, main piston 158, shim assembly 166, end valve 164 and regulating spring 162 mounted thereon. Specifically, control valve assembly 160 is sandwiched between flange 141 and main piston 158 while shim assembly 166 is sandwiched between main piston 158 and end valve 164. Furthermore, each of control valve assembly 160, main piston 158, and shim assembly 166 are secured in place by being sandwiched between flange 141 extending out of piston rod 130 and end valve 164 which is secured at the distal end piston rod 130. The assembled control valve assembly 160 can slide longitudinally within primary chamber 36 as piston rod 130 is advanced into and retracted out of primary chamber 36. As previously noted, main piston 158 seals against interior surface 14 of primary chamber 36 as main piston 158 slides within primary chamber 36. As such, main piston 158 divides primary chamber 36 into a distal primary chamber portion 36A disposed between main piston 158 and boundary 30 and a proximal primary chamber portion 36B disposed between main piston 158 and proximal end wall 26. The size of primary chamber portions 36A and 36B vary inversely as main piston 158 is moved within primary chamber 36.

In the above assembled configuration, control valve assembly 160 operates between an open position, as shown in FIG. 3, and a closed position, as shown in FIG. 1. In the closed position, control valve 196 has slid distally relative to valve guide 194 so that distal face 210 of control valve 196 (FIG. 3) biases against proximal face 170/proximal raised face 170B of main piston 158 and covers the proximal openings to compression ports 180. However, the proximal openings to rebound ports 182 on proximal lower face 170A remain openly exposed, i.e., the proximal openings to rebound ports 182 are spaced apart from control valve 196 so that open fluid communication is provided to rebound ports 182. As discussed below in greater detail, it is also noted that when control valve 196 is in the closed position, valve compartment 244 is collapsed between control valve 196 and valve guide 194 to a collapsed state having a first volume.

With reference to FIG. 3, control valve assembly 160 is in the fully open position. In this configuration, control valve 196 has slid proximally relative to valve guide 194 so that proximal face 212 of control valve 196 is biased against flange 141, thereby stopping further proximal movement of control valve 196. In this open position, control valve 196 is spaced apart from main piston 158 so that proximal openings to compression ports 180 are freely exposed and fluid is free to travel through the compression ports 180. It is also noted that in the open position, shoulder 218 of control valve 196 is spaced apart from proximal face 200 of base 198 of valve guide 194, thereby expanding valve compartment 244 to an expanded state so as to have a second volume that is larger than the first volume. The pressure in valve compartment 244 is greater in the collapsed state than in the expanded state. As such, the pressure within valve compartment 244 has the natural tendency to push control valve 196 into the open position under a force corresponding to the relative pressure within valve compartment 244.

Regulating spring 162 extends between main piston 158 and control valve 196 and provides a force that resiliently urges control valve 196 toward the open position. More specifically, in the depicted embodiment, regulating spring 162 is a coiled spring that encircles control valve 196 and has a proximal end disposed against proximal face of main piston 158 and, more specifically, against proximal lower face 170A. Regulating spring 162 also has an opposing distal end that is disposed against flange 214 of control valve 196.

Returning to FIG. 1, slidably disposed within chamber 16/secondary chamber 38 distal of boundary 30 and distal of piston rod 130 is a floating piston 250. Floating piston 250 has a central opening 260 through which stem 60 passes. Opening 260 has an interior surface with a seal 262 disposed thereon that seals against the exterior surface of stem 60. Seal 262 enables floating piston 250 to longitudinally slide along stem 60 but substantially precludes fluid or gas from passing between floating piston 250 and stem 60. Floating piston 250 also has a peripheral side 252 that extends between a distal face 254 and an opposing proximal face 256. A seal 258 is disposed on peripheral side 252. Seal 258 biases in sealed engagement against interior surface 14 of sidewall 18 of housing 12 so as to also enable floating piston 250 to selectively slide within chamber 16/secondary chamber 38 while substantially precluding fluid or gas from passing between floating piston 250 and sidewall 18/housing 12.

Floating piston 250 divides secondary chamber 38 into a distal secondary compartment 266 disposed between floating piston 250 and distal end wall 24 and a proximal secondary compartment 268 disposed between floating piston 250 and boundary 30. Compartments 266 and 268 each change in relative size as floating piston 250 slides within secondary chamber 38. Disposed within distal secondary compartment 266 is a compressible gas, such as air, while disposed within proximal secondary compartment 268 and within primary chamber 36 is a hydraulic fluid. As used in the specification and appended claims, the term “hydraulic fluid” is intended to include all types of fluids that can be used to transfer hydraulic pressures. Although hydraulic fluids are generally considered as being substantially non-compressible, it is appreciated that hydraulic fluids can be emulsified or have entrained gas, thereby making them slightly compressible.

With reference to FIGS. 1 and 3, the gas within distal secondary compartment 266 is disposed at a second pressure that is greater than a first pressure of the gas within valve compartment 244 and also is sufficiently high to counter the resilient force produced by regulating spring 162 on control valve 196. Accordingly, when control valve assembly 160 is statically positioned at any location along chamber 16/primary chamber 36, control valve 196 automatically moves to the above discussed closed position. For example, in the static position shown in FIG. 1 with piston rod 130 in a retracted position, control valve 196 is in the closed position. That is, the pressure within distal secondary compartment 266 is transferred through floating piston 250 and through the hydraulic fluid within proximal secondary compartment 268 and primary chamber 36 so to move control valve 196 into the closed position and collapse valve compartment 244. The gas can be delivered into distal secondary compartment 266, and thereby control the gas pressure, through a gas valve 270 mounted on housing 12 and communicating with distal secondary compartment 266. Gas valve 270 is shown mounted on distal end wall 24 but can be mounted on sidewall 18. Gas valve 270 typically comprises a Schrader valve but other types of gas valves can also be used.

In general, control valve 196 is moved to the closed position because the force applied by the hydraulic fluid on control valve assembly 160 is greater than the resistive force produced by regulating spring 162 and the gas within valve compartment 244. Although not required, it has been empirically determined that control valve assembly 160 more effectively operates under the applied forces to move between the open and closed positions if the surface area of distal face 210 of control valve 196 is less than at least 50%, preferably at least 40% and more preferably at least 30% of the surface area of proximal face 212 of control valve 196. (See FIG. 3).

FIG. 1 shows damper 10 assembled, as discussed above, with piston rod assembly 126/piston rod 130 in a retracted position so that main piston 158 and control valve assembly 160 are disposed at the proximal end of chamber 16/primary chamber 36 and floating piston 250 is disposed proximally within secondary chamber 38. In this static position, control valve assembly 160 is in the closed position so as to block fluid flow through compression ports 180 extending through main piston 158. During operation, when a force is applied to proximal end 136 of piston rod 130 that is greater than the force maintaining control valve assembly 160 in the closed position, piston rod assembly 126 with main piston 158 and control valve assembly 160 begin to move distally, i.e., along a compression stroke, within chamber 16/primary chamber 36. Specifically, when the force is applied to piston rod 130, the hydraulic fluid within compression ports 180 applies a counter force to control valve 196 that moves control valve 196 into or toward the open position, as shown in FIG. 3. The extent of opening of control valve 196 depends on the amount of force being applied to piston rod 130. Once control valve 196 is moved at least partially to the open position, piston rod 130 with main piston 158 and control valve assembly 160 begin to move distally within chamber 16/primary chamber 36 while the hydraulic fluid simultaneously flows from distal primary chamber portion 36A, through compression ports 180, and into proximal primary chamber portion 36B.

Control valve assembly 160 meters the flow of hydraulic fluid through compression ports 180 during the advancement of main piston 158. The extent to which control valve 196 slides proximally in part depends on the rate and magnitude of the force applied to piston rod 130. For example, if a large force is rapidly applied to piston rod 130, i.e., sharp hi-speed bump force, control valve assembly 160 is quickly moved to the fully open position as a result of the high pressures that are produced in distal primary chamber portion 36A and applied to distal face 210 of control valve 196. The hydraulic fluid can thus freely travel through compression ports 180 and around control valve 196, thereby allowing piston rod 130 to rapidly and easily advance toward distal primary chamber portion 36A. As such, the impact of the initial force on piston rod 130 is quickly absorbed by movement of piston rod 130.

It is noted that regulating spring 162 assists to easily and quickly move control valve 196 into the open or at least partially open position. That is, by using regulating spring 162 which is applying an urging force against control valve 196, less force is required by the hydraulic fluid to move control valve 196 into the open or at least partially open position. As a result, regulating spring 162 produces a smoother and quicker absorption of an impact force as the impact force is initially applied to piston rod 130. Thus, regulating spring 162 helps to minimize damping at the initial impact of a force on piston rod 130 and thus helps to produce a smoother ride. That is, without regulating spring 162, a greater force would need to be applied to piston rod 130 before control valve assembly 160 moves to the open position. It is appreciated that different stiffnesses of springs 162 can be used depending on the intended application and use. As such, damper 10 can be provided as a kit with a plurality of springs 162, such as at least 2, 3, 4, or 5, with each spring having a different stiffness.

In alternative embodiments, regulating spring 162 can be replaced with a spring (which can comprise any form of resilient member) positioned within valve compartment 244 (FIG. 3) to produce the urging force against control valve 196. However, there are unique advantages in placing regulating spring 162 outside of valve compartment 244. For example, placing a spring within valve compartment 244 can overly occupy the volume of valve compartment 244, thereby decreasing the operational efficiency of control valve assembly 160 or requiring control valve assembly 160 to be enlarged which increases size and cost of overall damper 10. Furthermore, placing regulating spring 162 outside of valve compartment 244 enables the use of larger springs which do not materially alter the size of damper 10 but which allow greater precision in selecting springs that have optimal resilient properties for optimal operation of control valve assembly 160. In addition, having regulating spring 162 outside of valve compartment 244 makes it easier to replace or switch regulating spring 162. Other benefits also exist.

In contrast to receiving a large rapid force, if a gradual small force is applied to piston rod 130, control valve 196 is only partially moved to the open position so that compression ports 180 remain partially restricted. This restriction of compression ports 180 decreases the flow of hydraulic fluid therethrough which in turn slows the movement of main piston 158 within chamber 16/primary chamber 36. However, even when a gradual force is applied, the use of regulating spring 162 can assist in an improved smooth absorption of the force relative to when regulating spring 162 is not used.

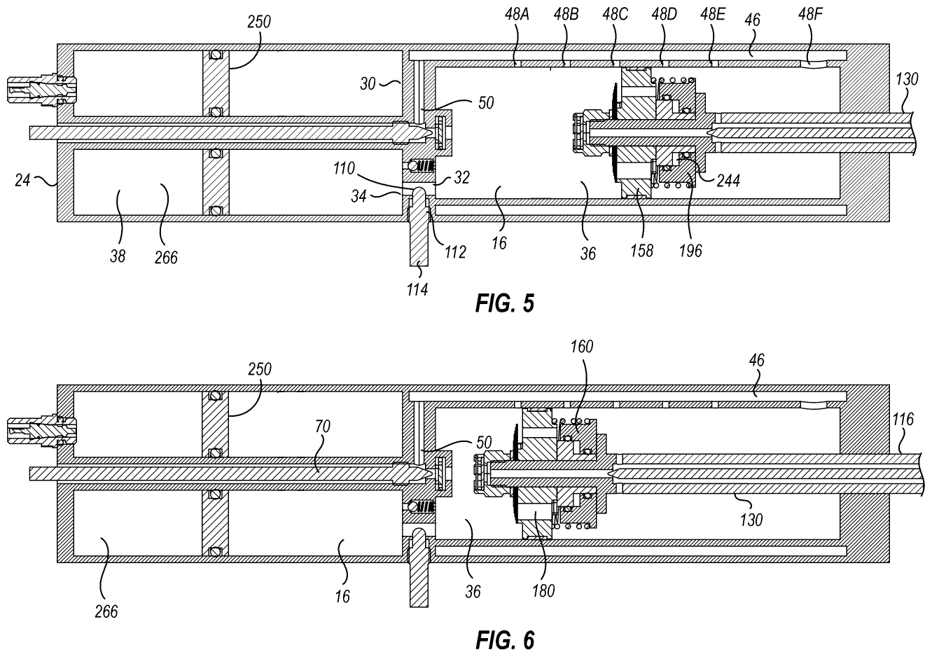

As depicted in FIG. 5, as more of piston rod 130 advances into chamber 16/primary chamber 36 during a compression stroke, piston rod 130 displaces a corresponding volume of the hydraulic fluid therein. Because the hydraulic fluid does not significantly compress, the displaced hydraulic fluid flows from primary chamber 36, through pressure control passage 110 in boundary 30, and into proximal secondary compartment 268. As the additional hydraulic fluid enters proximal secondary compartment 268, the hydraulic fluid causes floating piston 250 to progressively slide distally toward distal end wall 24 which further compresses the gas within distal secondary compartment 266. The pressure of the gas and the pressure of the hydraulic fluid increase simultaneously. As the pressure of the hydraulic fluid increases due to advancing piston rod 130 into chamber 16/primary chamber 36, the fluid pressure begins to progressively move control valve 196 back toward the closed position and thereby progressively collapses valve compartment 244. As control valve 196 moves toward the closed position, fluid flow through compression ports 180 is progressively restricted making it more difficult for the hydraulic fluid to pass therethrough. Accordingly, the farther piston rod 130 advances into chamber 16/primary chamber 36, the greater the resistance force that is applied against piston rod 130.

As previously discussed, regulating needle 114 can be selectively advanced into or withdrawn from pressure control passage 110 in boundary 30 so as to further help regulate the flow of hydraulic fluid therethrough. For example, as regulating needle 114 is advanced further into pressure control passage 110, the permitted flow rate of hydraulic fluid through pressure control passage 110 is decreased, thereby making it more difficult for piston rod 130 to advance into chamber 16/primary chamber 36 and making the overall suspension stiffer. In contrast, as regulating needle 114 is withdrawn from pressure control passage 110, the permitted flow rate of hydraulic fluid through pressure control passage 110 is increased, thereby making it easier for piston rod 130 to advance into chamber 16/primary chamber 36 and thus making the overall suspension softer. Regulating needle 114 is thus one mechanism that an operator can use to adjust/fine tune the stiffness of the suspension depending on the intended use and/or terrain. The use of regulating needle 114 is most effective in controlling damping during the application of a high impact force, i.e., high speed compression force, as opposed to constant gradual forces. For example, regulating needle 114 is most effective in regulating damping where piston rod assembly 126/piston rod 130 are traveling at speeds greater than 100 inches/second (254 cm/sec). The adjustment of regulating needle 114 can be automatic or manual.

One of the unique design features of boundary 30/pressure control passage 110 is that in at least one embodiment there are no shims, check valves, or other non-adjustable members that restrict or control the flow of hydraulic fluid through pressure control passage 110. For example, there are no shims, check valves, or other non-adjustable members mounted on first side face 32 or opposing second side face 34 of boundary 30 that restrict or control the flow of hydraulic fluid through pressure control passage 110. Rather, fluid flow through pressure control passage 110 is only regulated by regulating needle 114. As such, regulating needle 114 can be selectively retracted to enable a high fluid flow rate through pressure control passage 110 or advanced to selectively control the fluid flow rate. Where shims or other fixed fluid control mechanisms are used, such versatility is not enabled. Furthermore, by not having shims or other fixed flow restrictions, less force can be required to allow hydraulic fluid to pass through pressure control passage 110. Thus, pressure control passage 110 is configured to help eliminate high pressure spikes when damping. In alternative embodiments, regulating needle 114 and bore 112 in which it is received are optional and can be eliminated.

As depicted in FIG. 6, piston rod 130 is stopped from further advancement into chamber 16/primary chamber 36 when control valve assembly 160 returns to the closed position. This can occur when a sufficient length of piston rod 130 has entered chamber 16/primary chamber 36 such that the fluid pressure of the hydraulic fluid that moves control valve assembly 160 into the closed position (thereby precluding fluid travel through compression ports 180) is greater than the external force being applied to piston rod 130.

It is appreciated that the initial pressure of the gas within distal secondary compartment 266 can be selectively adjusted to adjust damping properties of damper 10. For example, by increasing the initial pressure of the gas within distal secondary compartment 266, such as by adding additional gas, increased pressure is initially applied by the hydraulic fluid that is forcing and maintaining control valve assembly 160 in the closed position. As such, a greater force must be applied to piston rod 130 to initially move control valve assembly 160 into the open or partially open position and allow movement of piston rod 130.

Furthermore, having a higher initial gas pressure within distal secondary compartment 266 causes control valve assembly 160 to close earlier as piston rod 130 is advanced into chamber 16/primary chamber 36. That is, the gas pressure within distal secondary compartment 266 (and thus also the hydraulic fluid pressure within primary chamber 36) increases exponentially as the volume of distal secondary compartment 266 is compressed. The increase in pressure is based on the compression ratio of distal secondary compartment 266, i.e., the starting volume of distal secondary compartment 266 versus the final volume of distal secondary compartment 266 when piston rod 130 is advanced into chamber 16/primary chamber 36. For example, if the starting volume of distal secondary compartment 266 is 100 cc and the final volume is 25 cc, the compression ratio is 4:1. As a result, the gas pressure and thus also the hydraulic fluid pressure in the final volume is four times the gas pressure in the starting volume. The pressure continues to increase exponentially as the volume of distal secondary compartment 266 decreases by compression.

It is also appreciated that the starting volume of distal secondary compartment 266 can be adjusted separately from the initial pressure therein so as to separately affect the damping properties. For example, in a first embodiment the initial volume of distal secondary compartment 266 can be 100 cc while in a second embodiment the initial volume can be 75 cc. Assuming the starting gas pressure in each embodiment is the same, the same initial force is applied to control valve assembly 160 as discussed above. However, for the same advancement of piston rod 130 in each of the embodiments, the compression ratio for the second embodiment is greater because the initial volume is smaller. As such, the rate of pressure increases and resulting damping force is greater for the second embodiment relative to the first embodiment.

Previously discussed bypass channel 46, together with bypass ports 48A-E and compression metering needle 70, can also be used to control damping properties during the compression stroke of piston rod assembly 126/piston rod 130. Bypass channel 46, together with bypass ports 48A-E and rebound metering needle 148, can also be used to control damping properties during the rebound stroke of piston rod assembly 126/piston rod 130. For example, in the configuration shown in FIG. 1, because of the proximal position of main piston 158, ports 48A-48E communicate with distal primary chamber portion 36A while port 48F communicates with proximal primary chamber portion 36B. Accordingly, as piston rod 130 and main piston 158 advance distally within primary compartment 36, a portion of the hydraulic fluid flows from distal primary chamber portion 36A through each of ports 48A-48E and into bypass channel 46. The hydraulic fluid then flows proximally along bypass channel 46 and into proximal primary chamber portion 36B through port 48F.

The large number, and thus corresponding large area, of ports 48A-48E enables relatively easy distal advancement of main piston 158 from the proximal starting position. However, as main piston 158 moves distally and passes select ones of ports 48, there becomes fewer ports 48 through which hydraulic fluid can pass from distal primary chamber portion 36A into bypass channel 46. For example, in the positioning shown in FIG. 5, only ports 48A-48C communicate directly with distal primary chamber portion 36A while each of ports 48D-48F now communicate directly with proximal primary chamber portion 36B. As such, because there are now fewer ports 48, i.e., less area, for hydraulic fluid to flow out of distal primary chamber portion 36A and into bypass channel 46, there is now greater resistance to distal advancement of piston rod 130 into primary chamber 36. Thus, ports 48 acting in concert with bypass channel 46 produce position sensitive damping where advancement of piston rod 130 into primary chamber 36 becomes more difficult, i.e., greater resistance is applied, the farther piston rod 130 is advanced distally into primary chamber 36, i.e., the more ports 48 main piston 158 has passed.

It is noted that the damping produced by ports 48 and bypass channel 46 is typically most effective, both during the compression stroke and the rebound stroke, for low speed velocities of piston rod assembly 126/piston rod 130, e.g., typically for velocities lower than 50 ips (inches per second) (127 cm/second). It is also noted that the damping properties of ports 48 and bypass channel 46 can act independent of control valve assembly 160 although both may act simultaneously on the movement of piston rod 130 depending on the force being applied.

With reference to FIG. 2, compression metering needle 70 can be used to adjust or fine tune the damping properties provided by bypass channel 46 during the compression stroke of piston rod assembly 126/piston rod 130. For example, when compression metering needle 70 is advanced so as to seat against mouth 80 on boundary 30, hydraulic fluid is precluded from flowing from distal primary chamber portion 36A, through inlet passage 56 and transfer passage 50 to bypass channel 46. However, as compression metering needle 70 is moved distally away from mouth 80, hydraulic fluid can increasingly flow from distal primary chamber portion 36A, through inlet passage 56 and transfer passage 50 to bypass channel 46 as rod assembly 126/piston rod 130 are advanced in primary chamber 36. Here it is noted that previously discussed check valve 84 is moved to the open position as hydraulic fluid is passed from distal primary chamber portion 36A against control plate 96. Inlet passage 56 thus effectively functions as an additional port 48 that further influences damping as main piston 158 and piston rod 130 are moved distally within primary chamber 36. In addition, the operator can selectively adjust the position of compression metering needle 70 relative to mouth 80 for selectively controlling the flow rate of hydraulic fluid from inlet passage 56 to bypass channel 46, thereby selectively adjusting/fine tuning the corresponding damping properties.

In view of the foregoing, during the compression stroke of piston rod 130 a wide variety of pressures can be applied against control valve assembly 160 and formed within primary chamber 36. These pressures can be produced by the varying types of loads, i.e., bump, gradual, varying, etc., that are applied against piston rod 130 and by the advancement of rod assembly 126/piston rod 130 into chamber 16. In turn, the resulting metering of hydraulic fluid: (1) through compression ports 180 on main piston 158 by control valve assembly 160, (2) through pressure control passage 110 on boundary 30, and/or (3) through bypass channel 46, during the compression stroke produces a variety of different damping effects. The damping effects can be: position sensitive as a result of the position of piston rod 130/main piston 158 within primary chamber 36; variable position and load sensitive depending on the position of piston rod 130/main piston 158, speed/force of the bump input, and pressure within the distal secondary compartment 266; and position and/or load adjustable, by varying the volume of and force of the pressure within distal secondary compartment 266.

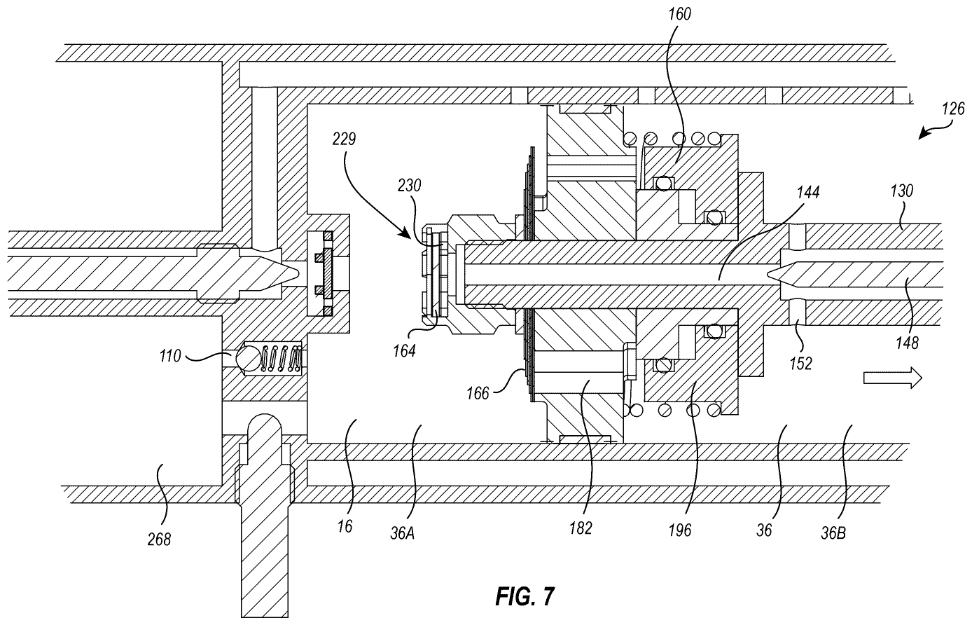

FIG. 7 shows piston rod assembly 126/piston rod 130 as the start of a rebound stroke where piston rod 130 is being drawn out of chamber 16/primary chamber 36. The rebound stroke typically occurs as a result of an external spring operable with piston rod 130. The external spring is compressed during the compression stroke and then resiliently rebounds causing piston rod 130 to move proximally along primary chamber 36 during the rebound stroke. During the rebound stroke, the fluid pressure applied by the hydraulic fluid keeps control valve assembly 160 in the closed position, thereby preventing the hydraulic fluid that is now proximal of control valve 196, i.e., within proximal primary chamber portion 36B, from passing through compression ports 180. Rather, the hydraulic fluid flows around the exterior of control valve assembly 160 and through rebound ports 182 by distally flexing shim assembly 166. Adjusting the stiffness and/or number of shims within shim assembly 166 can be used to adjust the flow rate of hydraulic fluid through rebound ports 182 and thereby adjust the resistance or damping on piston rod 130 as it travels along the rebound stroke.

During the rebound stroke, the pressurized gas within distal secondary compartment 266 forces hydraulic fluid within proximal secondary compartment 268 to flow through pressure control passage 110 and back into distal primary compartment 36A. Because the rebound stroke is typically produced by the resilient expansion of the compressed external spring, the rebound stroke is typically much slower than the compression stroke. However, use of pressure control passage 110 by itself is typically inadequate to produce a timely rebound stroke for piston rod assembly 126/piston rod 130. That is, a limited flow rate of hydraulic fluid through pressure control passage 110, which is typically constricted, restricts the ability of rod assembly 126/piston rod 130 to freely rebound under the force of the external spring. In addition, inadequate flow rate of the hydraulic fluid through boundary 30 during the rebound stroke can produce cavitation of the hydraulic fluid within distal primary compartment 36A, which can be detrimental to operation of the damper.

Accordingly, as previously discussed with regard to FIG. 2, return passage 280 extends through boundary 30 and is also used for the flow of hydraulic fluid from proximal secondary compartment 268 to distal primary compartment 36A during the rebound stroke. Specifically, the pressure within distal secondary compartment 266 is sufficient to move check valve 282 into the open position so that the hydraulic fluid can flow through return passage 280 from proximal secondary compartment 268 to distal primary compartment 36A during the rebound stroke. Typically, return passage 280 and pressure control passage 110 are sized so that a sufficient flow rate of hydraulic fluid can flow from proximal secondary compartment 268 to distal primary compartment 36A during the rebound stroke to allow rod assembly 126/piston rod 130 to freely rebound unconstrained by the flow rate of hydraulic fluid through boundary 30. As a result, the rate of the rebound stroke can be adjusted by tensioning of the external spring without risk of cavitation of the hydraulic fluid within distal primary compartment 36A.

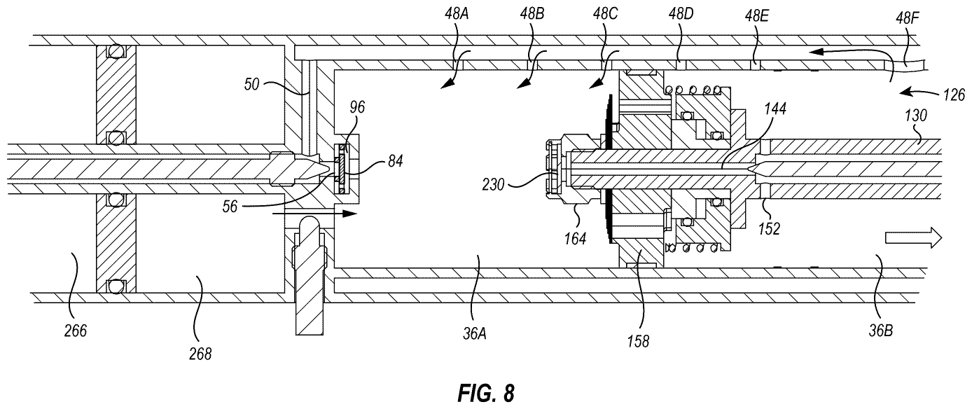

Bypass channel 46 can be used to influence the rebound rate of rod assembly 126/piston rod 130. That is, as shown in FIG. 8, as rod assembly 126/piston rod 130 moves proximally along the rebound stroke, at least part of the hydraulic fluid can be displaced by flowing from proximal primary chamber portion 36B, through ports 48 proximal of main piston 158, along bypass channel 46, and into distal primary chamber portion 36A through ports 48 distal of main piston 158. As main piston 158 moves proximally, more ports 48 are exposed distal of main piston 158, thereby allowing the hydraulic fluid to more freely flow through bypass channel and thereby decrease damping. As such, damping by bypass channel 46 is position sensitive during rebound and is most effective, with damping being the highest, at the start of the rebound stroke and is the least effective, with damping being the lowest, at the end of the rebound stroke. It is noted that as piston rod 130 travels proximally along the rebound stroke and hydraulic fluid flows distally within bypass channel 46, a portion of the hydraulic fluid travels along transfer passage 50 and into inlet passage 56 where the fluid moves control plate 96 proximally so as to close check valve 84, thereby precluding the hydraulic fluid from traveling through inlet passage 56 and into distal primary chamber portion 36A. Check valve 84 is used to restrict hydraulic fluid flow from chamber portion 36B to chamber portion 36A, thereby allowing the rebound cycle hydraulic fluid flow to be entirely controlled by the rebound metering needle 148, bypass ports 48A-E, and rebound shims 166.

The primary mechanism for adjustably controlling the rebound rate of rod assembly 126/piston rod 130 is through the use of rebound metering needle 148. Specifically, as rod assembly 126/piston rod 130 travels proximally along the rebound stroke, hydraulic fluid flows from proximal primary chamber portion 36B into channel 144 through port 152. The fluid then travels distally along channel 144 and exits into distal primary chamber portion 36A through end valve 164. The flowing hydraulic fluid moves control plate 230 proximally so that check valve 229 is in the open position. As previously discussed, rebound metering needle 148 can be selectively adjusted to control the flow rate of hydraulic fluid from proximal primary chamber portion 36B into channel 144. In turn, restricting the flow rate restrains or dampens movement of rod assembly 126/piston rod 130 along the rebound stroke. Thus, by adjusting the position of rebound metering needle 148, the rebound rate of rod assembly 126/piston rod 130 can be selectively regulated based on intended use and/or desired damping.

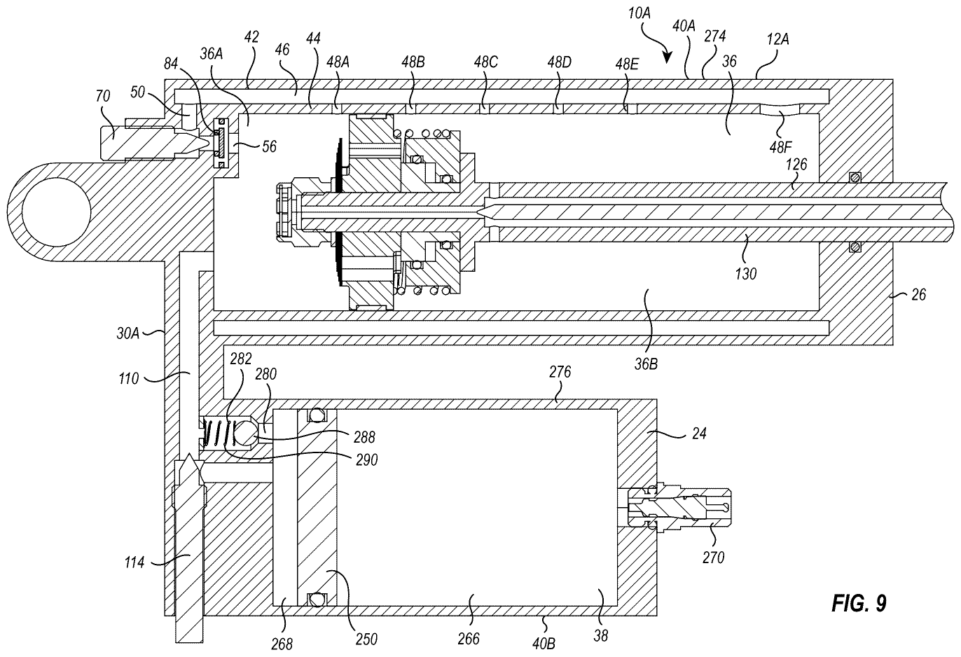

It is appreciated that the disclosed suspension damper can have a variety of different configurations. For example, depicted in FIG. 9 is an alternative embodiment of a suspension damper 10A incorporating features of the present disclosure. Damper 10A has a piggy-back configuration and like elements between damper 10 and damper 10A are identified by like reference numbers. Furthermore, the disclosure and alternatives discussed above with regard to damper 10 are also applicable to like elements of damper 10A unless indicated otherwise. Damper 10A includes a housing 12A that generally comprises a primary housing 274 bounding primary chamber 36, a secondary housing 276 bounding secondary chamber 38, and a boundary 30A that extends between primary housing 274 and secondary housing 276. Boundary 30A bounds pressure control passage 110 that extends between primary chamber 36 and secondary chamber 38. Primary housing 274 includes primary sidewall portion 40A that includes outer sidewall 42 and inwardly disposed inner sidewall 44 that extends between proximal end wall 26 and boundary 30A. Secondary housing 276 includes secondary sidewall portion 40B extending between distal end wall 24 and boundary 30A. In contrast to damper 10 wherein the primary housing and the secondary housing are longitudinally aligned and can have a common central longitudinal axis, in damper 10A primary housing 274 and secondary housing 276 are laterally spaced apart and can each have a central longitudinal axis that can be disposed in parallel alignment to each other.

Floating piston 250 is slidably disposed within secondary chamber 38 and divides secondary chamber 38 into distal secondary compartment 266 and proximal secondary compartment 268. Again, a gas is disposed within distal secondary compartment 266, such as by being inserted through gas valve 270, while a hydraulic fluid is disposed within proximal secondary compartment 268 and primary chamber 36.

Piston rod assembly 126 is slidably disposed within primary chamber 36 and can have the same components, alternatives, and operate in the same manner as previously discussed above with regard to damper 10. To that end, as piston rod assembly 126/piston rod 130 is advanced into primary chamber 36, the displaced hydraulic fluid flows through pressure control passage 110 and into proximal secondary compartment 268 which moves floating piston 250 distally and increases the fluid and gas pressure, as discussed above with damper 10. Regulating needle 114 is threadedly mounted on boundary 30A and is used to control the flow rate of hydraulic fluid through pressure control passage 110 and thereby enable selective adjustment of damping properties as previously discussed above with regard to damper 10.

Damper 10A includes return passage 280 that extends from proximal secondary compartment 268 to pressure control passage 110 or can extend directly to primary chamber 36/distal primary chamber portion 36A. Check valve 282 is disposed in or is otherwise associated with return passage 280 so as to allow hydraulic fluid to flow out of proximal secondary compartment 268 but precludes hydraulic fluid from flowing from pressure control passage 110, through return passage 280 into proximal secondary compartment 268. Check valve 273 comprises ball 288, spring 290, and the other components as previously discussed. Other types of one-way valves/check valves, such as those previously discussed herein, can also be used. This configuration enables a tight restriction on the flow of hydraulic fluid from distal primary chamber portion 36A to proximal secondary compartment 268 during the compression stroke, which is helpful in controlling damping properties, while simultaneously providing an increased flow rate of hydraulic fluid from proximal secondary compartment 268 to distal primary chamber portion 36A during the rebound stroke, which enables piston rod assembly 126/piston rod 130 to rebound without being restricted by the flow rate of the hydraulic fluid and without risk of cavitation of the hydraulic fluid.

Finally, damper 10A also includes bypass channel 46 disposed between outer sidewall 42 and inner sidewall 44 with ports 48A-48E extending through inner sidewall 44 so as to communicate with primary chamber 36. Bypass channel 46 operates with ports 48 to produce position sensitive damping the same as previously discussed with regard to damper 10. Furthermore, distal primary chamber portion 36A also communicates with bypass channel 46 through transfer passage 50 and inlet passage 56 formed on boundary 30A. Compression metering needle 70 is mounted on boundary 30A to control the flow rate of hydraulic fluid through inlet passage 56 and transfer passage 50 during the compression stroke, thereby permitting further fine tuning of the compression stroke damping properties. Check valve 84 prevents the flow of hydraulic fluid from bypass channel 46 to distal primary chamber portion 36A through transfer passage 50 and inlet passage 56 during the rebound stroke.

Unless discussed otherwise, damper 10A can operate in the same manner as damper 10, as discussed above, and previously discussed alternatives for damper 10 are also applicable to damper 10A.

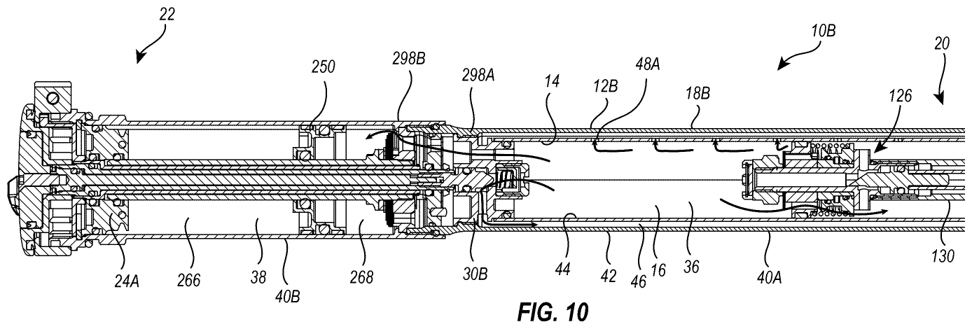

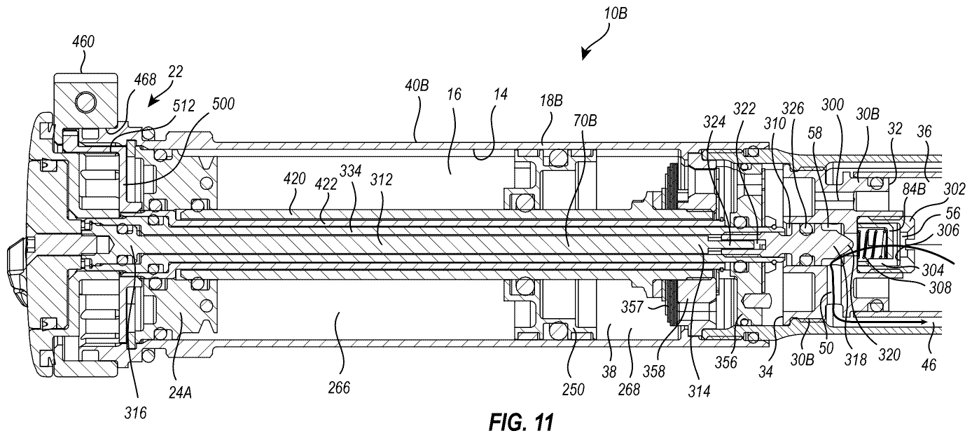

Depicted in FIG. 10 is another alternative embodiment of a suspension damper 10B incorporating features of the present disclosure. Like elements between damper 10 and damper 10B are identified by like reference numbers. Furthermore, the disclosure and alternatives discussed above with regard to damper 10 are also applicable to like elements of damper 10B unless indicated otherwise. In general, damper 10B includes a housing 12B having interior surface 14 that bounds chamber 16. Housing 12B comprises a cylindrical sidewall 18B that extends between proximal end 20 and opposing distal end 22. Proximal end wall 26 (FIG. 1) is disposed at proximal end 20 while distal end wall 24 is disposed at distal end 22. A boundary 30B radially inwardly projects from interior surface 14 of sidewall 18B so as to laterally span across chamber 16. Boundary 30B is spaced apart from but is located between proximal end wall 26 and distal end wall 24. Boundary 30B has first side face 32 that faces proximal end wall 26 and opposing second side face 34 (FIG. 11) that faces distal end wall 24. Boundary 30B divides chamber 16 into primary chamber 36 extending between boundary 30B and proximal end wall 26 and a secondary chamber 38 extending between boundary 30B and distal end wall 24. It is noted that in this embodiment that sidewall 18B comprises a tubular proximal sidewall portion 298A and a separate tubular distal sidewall portion 298B that are secured together, such as by threaded coupling or press fit connection. Using two sidewall portions 298A and B that are coupled together assists in the assembly of damper 10B.

Sidewall 18B is also defined as comprising primary sidewall portion 40A extending between proximal end wall 26 (FIG. 1) and boundary 30B and secondary sidewall portion 40B extending between boundary 30 and a distal end wall 24A. Primary sidewall portion 40A comprises outer sidewall 42 and inner sidewall 44 with bypass channel 46 disposed therebetween. Previously discussed ports 48A-48F (FIG. 1) pass through inner sidewall 44 so as to provide fluid communication between primary chamber 36 and bypass channel 46. Slidably disposed within primary chamber 36 is previously discussed piston rod assembly 126 that includes piston rod 130. Piston rod assembly 126 can include the same components and function in the same manner as previously discussed with regard to damper 10. In addition, piston rod assembly 126 can operate with ports 48 and bypass channel 46 to achieve the same positioning sensitive damping as previously discussed with regard to damper 10.

Turning to FIG. 11, boundary 30B comprises a fluid passage 300 extending therethrough between first side face 32 and opposing second side face 34. Boundary 30B also includes inlet passage 56, control passage 58, and transfer passage 50, wherein transfer passage 50 provides fluid communication between inlet passage 56 and bypass channel 46. Disposed within inlet passage 56 is an alternative embodiment of a check valve 84B. In general, check valve 84B comprises a cap 302 mounted on boundary 30B and having inlet passage 56 passing through an end face thereof. A plunger 304 is disposed between boundary 30B and cap 302 and is urged against an inside face 306 of cap 302, that encircles inlet passage 56, by a spring 308. An exterior surface of plunger 304 has a different cross-sectional configuration than a cross-sectional configuration of the interior surface of cap 302. For example, the cross-sectional configuration of cap 302 can be circular while the cross-sectional configuration of plunger 304 can be triangular or have another polygonal or other configuration.

In the above configuration, check valve 84 can be moved between an open and closed position. As piston rod assembly 126 (FIG. 10) is moved distally along the compression stroke, plunger 304 is moved distally away from inside face 306 of cap 302, as shown in FIG. 11, by the compression of spring 308. In this open position, fluid flows into inlet passage 56, around the exterior of plunger 304, and through transfer passage 50 to bypass channel 46. As piston rod assembly 126 moves proximally along the rebound stroke, spring 308 urges plunger 304 back against inside face 306 of cap 302. In this closed position, fluid is precluded or restricted from flowing from bypass channel 46, through transfer passage 50 and into primary chamber 36 through inlet passage 56. In alternative embodiments, other configurations of check valves, such as those discussed or depicted herein, can also be used.

Continuing with FIG. 11, a recess 310 is centrally formed on second side face 34 of boundary 30B that bounds control passage 58. A compression metering needle 70B is at least partially disposed within control passage 58. Specifically, compression metering needle 70B comprises an elongated inner shaft 312 having a proximal end 314 and an opposing distal end 316. Coupled with proximal end 314 is a nose portion 318 terminating at a tapered nose 320. Inner shaft 312 and nose portion 318 can be coupled together using a variety of different techniques. In the depicted embodiment, the coupling is accomplished by inserting a tenon 324 in the form of a flat tongue disposed at proximal end 314 of shaft 312 into a mortis 322 in the form a complementary U-shaped slot formed on a distal end of nose portion 318. Other complementary mortis and tenon configurations can also be used. This assembly provides a simple coupling between the parts during assembly of damper 10B. A seal 326, such as in the form of an O-ring, encircles nose portion 318 and biases against an interior surface of recess 310 so as to form a sealed engagement therewith.

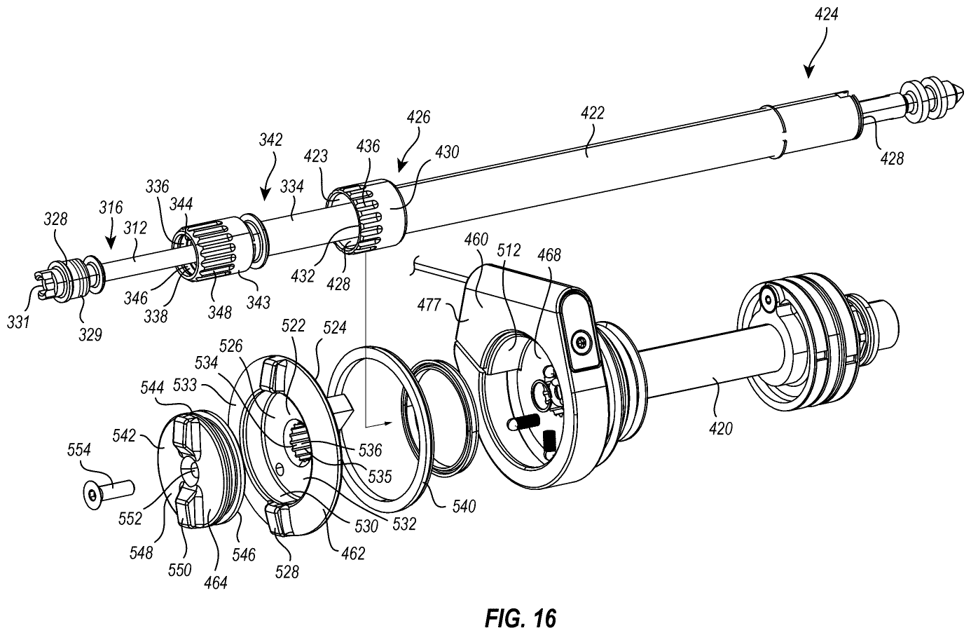

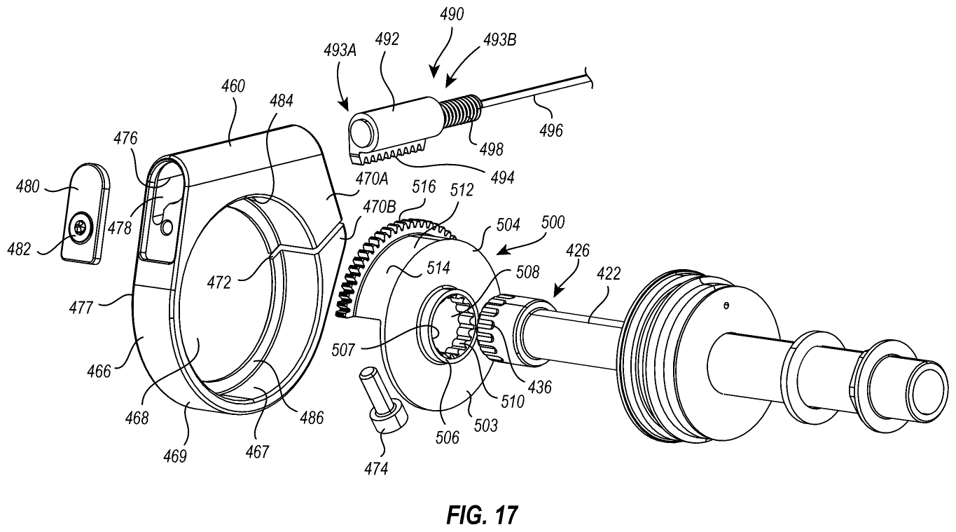

With reference to FIG. 16, an enlarged head 328 is formed at distal end 316 of inner shaft 312 and has an encircling annular thread 329 formed thereat. A mounting opening is formed on a distal terminal end face of inner shaft 312 and is configured to receive a fastener 554, as will be discussed below. Damper 10B comprises a plurality of concentrically disposed shafts that each perform a separate function. Specifically, as shown in FIGS. 11 and 16 and as will be discussed below in further detail, inner shaft 312 is rotatably disposed within a tubular control shaft 334; control shaft 334 is rotatably disposed within a tubular regulating shaft 422; and regulating shaft 422 is rotatably disposed within a tubular outer shaft 420.

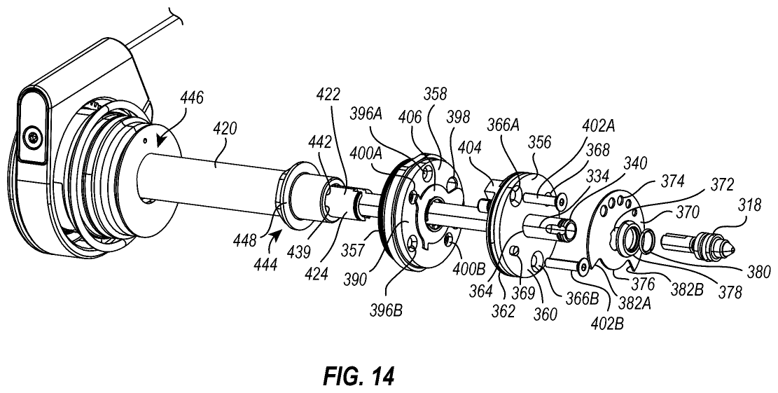

Control shaft 334 has an interior surface 336 bounding a passage 338 that extends between a proximal end 340 (FIG. 14) and an opposing distal end 342. An enlarged head 343, typically having a cylindrical configuration, is formed at distal end 342 of control shaft 334 and bounds a recess 344 forming a portion of passage 338. An annular thread 346 is formed on the interior surface 336 of head 343. Recess 344 is configured to receive head 328 of inner shaft 312 so that threads 329 on head 328 can threadedly engage threads 346 on head 343. Linear grooves 348 are radially spaced apart around the exterior surface of head 343 of control shaft 334. Grooves 348 start at a terminal distal end of head 343 and extend a proximal distance in parallel alignment with a central longitudinal axis of control shaft 334.

As depicted in FIG. 16, regulating shaft 422 has an interior surface 423 bounding a passage 428 extending between a proximal end 424 and an opposing distal end 426. An enlarged head 430, typically having a cylindrical configuration, is formed at distal end 426 of regulating shaft 422 and bounds a recess 432 forming a portion of passage 428. Recess 432 is configured to receive at least a portion of head 343 of control shaft 334. Linear grooves 436 are radially spaced apart around the exterior surface of head 430 of regulating shaft 422. Grooves 436 start at a terminal distal end of head 430 and extend a proximal distance in parallel alignment with a central longitudinal axis of regulating shaft 422.

With reference to FIG. 14, outer shaft 420 has an interior surface 439 bounding a passage 442 extending between a proximal end 444 and an opposing distal end 446. A flange 448 encircles and radially outwardly projects from outer shaft 420 toward but spaced back from the terminus of proximal end 444.

As will also be discussed below in further detail, compression metering needle 70B, which includes inner shaft 312, can be selectively advanced into inlet passage 56 and out of inlet passage 56 for regulating the flow of hydraulic fluid from inlet passage 56 to bypass channel 46 through transfer channel 50. For the same reasons as previously discussed with regard to damper 10, controlling fluid flow rate through transfer channel 50 regulates the compression damping properties of damper 10B.

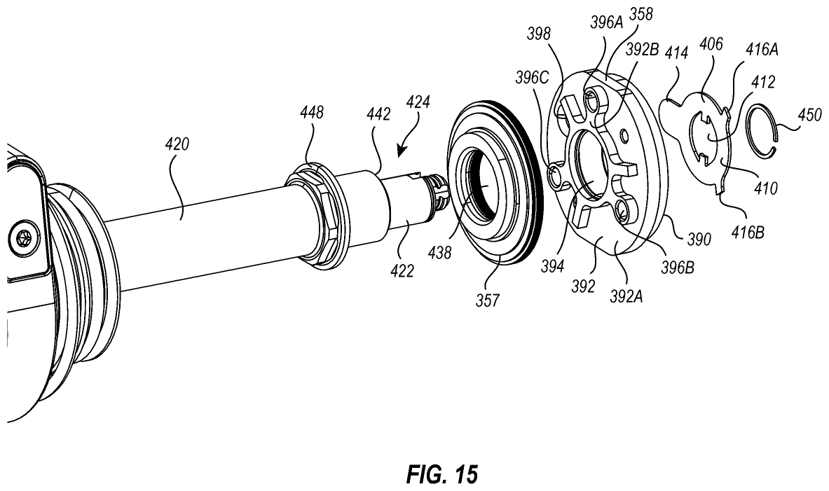

As perhaps best depicted in FIGS. 11 and 13-15, damper 10B also includes a control plate 356 disposed within secondary chamber 38 distal of boundary 30B, a regulating plate 358 disposed within secondary chamber 38 distal of control plate 356, a shim assembly 357 disposed within secondary chamber 38 distal of regulating plate 358, and floating piston 250 disposed within secondary chamber 38 distal of regulating plate 358. Floating piston 250 divides secondary chamber 38 into distal secondary compartment 266 and proximal secondary compartment 268. Floating piston 250 operates in the same manner as discussed above with regard to damper 10 and pressurized gas can be fed into distal secondary compartment 266 as needed. To simplify the views, floating piston 250 is not shown in FIGS. 14 and 15.

Both of control plate 356 and regulating plate 358 having an outer perimeter edge sealed against the interior surface 14 of sidewall 18/secondary sidewall portion 40B and radially inwardly project from interior surface 14 so as to laterally span across secondary chamber 38. Control plate 356 and regulating plate 358 are also fixed so that they do not move relative to sidewall 18 during use. As depicted in FIG. 14, control plate 356 has a proximal face 360 and an opposing distal face 362 with a central shaft opening 364, a pair of spaced apart mounting openings 366A and 366B, and a control passage 368 passing through control plate 356 between opposing faces 360 and 362. An optional stop 369 outwardly projects from proximal face 360.

An orifice plate 370 is rotatably mounted on or directly adjacent to proximal face 360 of control plate 356. Orifice plate 370 has a central shaft port 372 extending therethrough and a plurality of different sized orifices 374 extending therethrough. Orifices 374 are radially spaced apart and are positioned so that as orifice plate 370 is rotated relative to control plate 356, orifices 374 consecutively align with control passage 368. Orifices 374 are typically formed to progressively increase or decrease in size in consecutive order with the largest orifice 374 being the same size or smaller than control passage 368. Control passage 368 and orifices 374 typically have a circular transverse cross section but other shapes, such as polygonal, can also be used. The number of orifices 374 can vary based on intended use and the desired level of damping adjusting. In one embodiment, the number of orifices 374 can comprise at least two, three, four, five, six, or eight or be in a range between any two of the foregoing.

Proximal end 340 of control shaft 334 is securely fixed to orifice plate 370 to that rotation of control shaft 334 facilitates rotation of orifice plate 370 relative to control plate 356. In the depicted embodiment, shaft port 372 of orifice plate 370 has a non-circular transverse cross section while proximal end 340 of control shaft 334 has a complementary configuration shaft port 372. As a result, orifice plate 370 is rotatably locked with control shaft 334 when proximal end 340 of control shaft 334 is received within shaft port 372. Furthermore, a washer 378 and locking ring 380 are mounted on proximal end 340 of control shaft 334 projecting through shaft port 373 to longitudinally lock orifice plate 370 to control shaft 334. It is appreciated that a variety of different configures can be used to interlock control shaft 334 and orifice plate 370 and that a variety of different techniques, such as thread connection, press fit, welding, and the like, can be used to make the coupling. However, the current design simplifies production assembly.

As depicted in FIGS. 13 and 14, a notch 376 can optionally be formed on the perimeter of orifice plate 370 which terminates at opposing shoulders 382A and 382B. Stop 369 is received within notch 376 so as to limit rotation of orifice plate 370 between a first position, as shown in FIG. 13, wherein shoulder 382A butts against stop 369 so that a smallest orifice 374A aligns with control passage 368, and a second position wherein shoulder 382B butts against stop 369 so that a largest orifice 374E aligns with control passage 368.

As depicted in FIGS. 14 and 15, regulating plate 358 has a proximal side face 390 and an opposing distal side face 392 with a central shaft opening 394, a plurality of spaced apart regulating passages 396A-C, and a fluid passage 398 each passing through regulating plate 358 between opposing faces 390 and 392. A pair of spaced apart mounting openings 400A and 400B are formed on proximal side face 390 and are configured to receive fasteners 402A and 402B that pass through mounting openings 366A and 366B, respectively, on control plate 356 for securing regulating plate 358 to control plate 356. One or more spacers 404 can outwardly project from distal face 362 of control plate 356 so as to provide a gap between control plate 356 and regulating plate 358 when secured together.

As shown in FIG. 15, distal side face 392 comprises a distal lower face 392A and a distal raised face 392B wherein distal raised face 392B is outwardly spaced apart from distal lower face 392A. Regulating passages 396A-C pass through distal raised face 392B while fluid passage 398 passes through distal lower face 392A but is spaced apart from distal raised face 392B.

Shim assembly 357 is typically circular having a shaft opening 438 centrally extending therethrough. Shim assembly 357 is configured to bias against distal raised face 392B of regulating plate 358. As a result of distal raised face 392B being raised or offset from distal lower face 392A, shim assembly 357 directly covers the distal openings to regulating passages 396 so as to restrict fluid flow therethrough but does not directly cover the distal opening of fluid passage 398 so that fluid can flow therethrough substantially unrestrained. Shim assembly 357 can comprise a single shim or a plurality of stacked shims. For example, FIG. 15 depicts shim assembly 357 as a plurality of flexible annular shims stacked together with each consecutive distal shim having a smaller outer diameter.

Rotatably mounted on or directly adjacent to proximal side face 390 of regulating plate 358 is a blocking plate 406. Blocking plate 406 is configured so that it can be selectively rotated between a first position wherein blocking plate 406 is spaced apart from regulating passage 396 (as show in FIG. 14) so that fluid can freely flow therethrough and a second position wherein the blocking plate 406 covers regulating passage 396 so as to preclude or at least restrict the flow of fluid therethrough. In the depicted embodiment, blocking plate 406 comprises a body 410, a shaft passage 412 centrally extending through body 410, a block 414 radially outwardly projecting from a perimeter of body 410, and an optional pair of spaced apart shoulders 416A and 416B radially outwardly projecting from a perimeter of body 410.

Shaft passage 412 has a non-circular transverse cross section that is configured to couple with regulating shaft 422 so that rotation of regulating shaft 422 facilitates rotation of blocking plate 406 relative to regulating plate 358. Specifically, proximal end 424 of regulating shaft 422 has a non-circular transverse cross section complementary to the shape of shaft passage 412 of blocking plate 406. As such, regulating shaft 422 is coupled and rotatably locked with blocking plate 406 by advancing proximal end 424 into shaft passage 412. In turn, a looking ring 450 can be mounted on proximal end 424 of regulating shaft 422 passing through blocking plate 406 to prevent blocking plate 406 from sliding off of regulating shaft 422. It is appreciated that a variety of different configures can be used to interlock regulating shaft 422 and blocking plate 406 and that a variety of different techniques, such as thread connection, press fit, welding, and the like, can be used to make the coupling. However, the current design simplifies production assembly.

During use, regulating shaft 422 is selectively rotated which causes blocking plate 406 to rotate relative to regulating plate 358. Blocking plate 406 can be rotated between the first position wherein block 414 of blocking plate 406 is spaced apart from regulating passage 396 (as show in FIG. 14) so that fluid can freely flow therethrough and the second position wherein block 414 of blocking plate 406 covers regulating passage 396 so as to preclude or at least restrict the flow of fluid therethrough. It is appreciated that blocking plate 406 can have a variety of different configurations to facilitate the covering and uncovering of regulating passage 396. Shoulders 416A and 416B can operate with stops projecting from control plate 356 and/or regulating plate 358 to limit rotation of blocking plate 406 between the first position and the second position.

In view of the foregoing, during assembly, proximal end 314 of inner shaft 312 is passed through floating piston 250, shim assembly 357, regulating plate 358, blocking plate 406, control plate 356, and orifice plate 370 and is coupled with nose portion 318 that is slidably disposed on boundary 30B. Nose portion 318 rotates concurrently with inner shaft 312. Proximal end 340 of control shaft 334 is passed through floating piston 250, shim assembly 357, regulating plate 358, blocking plate 406, control plate 356 and is coupled with orifice plate 370. Orifice plate 370 is captured between control plate 356 and boundary 30B and rotates concurrently with control shaft 334. Proximal end 424 of regulating shaft 422 is passed through floating piston 250, shim assembly 357, regulating plate 358, and is coupled with blocking plate 406. Regulating plate 358 is coupled to control plate 356 by fasteners 402A and 402B but are spaced apart by spacers 404 to enable blocking plate 406 to freely rotate within a space therebetween. Blocking plate 406 rotates concurrently with regulating shaft 422. Proximal end 444 of outer shaft 420 is passed through shim assembly 357 and is received within shaft opening 394 of regulating plate 358. Outer shaft 420 is secured so that flange 448 presses and secures shim assembly 357 against distal raised face 392B of regulating plate 358 so as to cover the distal openings to regulating passages 396.

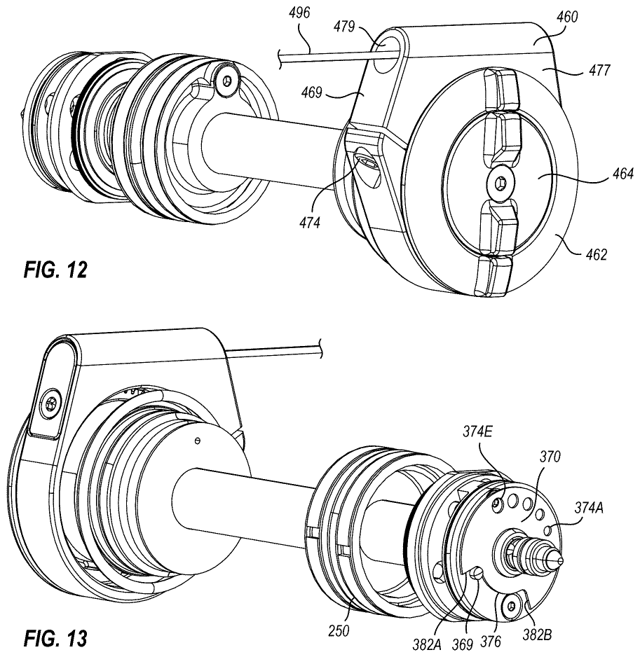

The components used in rotating the above shafts will now be discussed. Specifically, with reference to FIG. 16, damper 10A further comprises a collar 460, an outer knob 462 that nests within collar 460, and an inner knob 464 that nests within outer knob 462. With reference to FIGS. 16 and 17, collar 460 includes a C-shaped body 466 having an interior surface 467 partially encircling an opening 468 passing therethrough and having an exterior surface 469. Body 466 terminates at opposing facing ends 470A and 470B with a slot 472 bound therebetween. Opening 468 can be constricted by using a fastener 474 to secure and draw ends 470A and 470B together. A linear channel 476 is recessed into a section of body 466 and includes an enlarged inlet 478 and an opposing constricted outlet 479 (FIG. 12) each extending through exterior surface 469. Inlet 478 can be selectively covered by a panel 480. A fastener 482 is used to removably secure panel 480 to body 466. A slot 484 passes through interior surface 467 of body 466 so as to provide communication between channel 476 and opening 468. A flange 486 radially inwardly projects from interior surface 467 at a distal side 477 of body 466 so as to partially encircle opening 468.

A rack assembly 490 is slidably disposed within channel 476. Rack assembly 490 comprises an elongated stem 492 extending between a first end 493A and an opposing second end 493B. A linear gear 494 outwardly projects from and extends along a length of stem 492 between ends 493A and 493B. A cable 496 outwardly projects from second end 493B with a spring 498 encircling cable 496. Rack assembly 490 is fed into channel 476 through inlet 478 so that cable passes out through outlet 479 (FIG. 12) but stem 492 and spring 498 are captured within channel 476. In this position, linear gear 494 communicates with opening 468 through slot 484. Channel 476 is longer than linear gear 494/rack assembly 490 so that linear gear 494/rack assembly 490 can laterally side back and forth a distance within channel 476.

A pinion assembly 500 is also provided and includes a base plate 503, typically having a circular configuration and extending to an outer perimeter edge 504. A stem 506 is centrally formed on base plate 503 and has an interior surface 507 bounding an opening 508 passing through base plate 503. A plurality of linear ribs 510 are radially spaced apart around interior surface 507 and are configured to be received within grooves 436 formed on the distal end 426 of regulating shaft 422. Specifically, during assembly, distal end 426 of regulating shaft 422 is advanced into opening 508 of stem 506 so that ribs 510 and grooves 435 mesh together, thereby interlocking regulating shaft 422 with pinion assembly 500 so that rotation of pinion assembly 500 facilitates rotation of regulating shaft 422. Furthermore, because grooves 436 have a limited length, regulating shaft 422 can only advance a limited distance into opening 508. In alternative embodiment, it is appreciated that ribs 510 and grooves 435 can be replaced with alternative interlocking shapes and structures and that other interlocking mechanisms can also be used. However, the current assembly simplifies production assembly.

Pinion assembly 500 also includes an arced sleeve segment 512 distally projecting from base plate 503, typically at perimeter edge 504. In alternative embodiments, sleeve segment 512 can be replaced with a circular sleeve projecting from base plate 503 but the additional material is typically not needed. Sleeve segment 512 has a curved outside face 514 that generally has a contour complementary to interior surface 467 of collar 460. A curved gear segment 516 outwardly projects from outside face 514 so as to partially encircle about a central axis extending through opening 508. During assembly, sleeve segment 512 is received within opening 468 of collar 460 so that curved gear segment 516 complementary meshes with linear gear 494 of rack assembly 490 projecting through slot 484. Curved gear segment 516 can also butt against flange 486 to help facilitation and maintain prior alignment between curved gear segment 516 and linear gear 494.

As shown in FIG. 11, distal end 22 of sidewall 18B is also received within opening 468 of collar 460 radially outward from pinion assembly 500/sleeve segment 512. Collar 460 is securely clamped onto sidewall 18B by fastener 474 (FIG. 17). In the assembled configuration, pulling on cable 496 (see FIGS. 12 and 17) causes lateral displacement of linear gear 494/rack assembly 490 which in turn causes rotational displacement of pinion assembly 500 and which in turn causes rotational displacement of regulating shaft 422. The rotation of regulating shaft causes blocking plate 406 (FIG. 14) to move between the open and closed position. It is appreciated that cable 496 can be connected to a remote automatic or manual lever for movement of rack assembly 490. Spring 498 can be used for tensioning cable 496 and/or resiliently rebounding rack assembly 490, such as when the lever is released.

Turning to FIG. 16, outer knob 462 comprises a floor 522, that is typically circular, having a proximal face 524 and an opposing distal face 526. An annular perimeter wall 530 projects distal from floor 522 at the outer perimeter thereof. Perimeter wall 530 and floor 522 bound an annular recess 532. A flange 533 radially outwardly projects from perimeter wall 530 at or toward the distal end thereof while one or more grips 528 can outwardly project from flange 533. A tubular stem 534 centrally projects proximal from floor 522 so as to outwardly project from proximal face 524. Stem 534 has an interior surface that bounds an opening 535 extending through outer knob 462. A plurality of radially spaced apart, linear ribs 536 inwardly projecting from the interior surface into opening 535. Ribs 536 extend parallel to a central longitudinal axis passing through opening 535. Ribs 536 are configured to be received within grooves 348 formed on distal end 342 of control shaft 334. Specifically, during assembly, distal end 342 of control shaft 334 is advanced into opening 535 of stem 534 so that ribs 536 and grooves 348 mesh together, thereby interlocking control shaft 334 with outer knob 462. As a result, rotation of outer knob 462, such as through gripping and rotating grips 528, facilitates rotation of control shaft 334. Furthermore, because grooves 348 have a limited length, control shaft 334 can only advance a limited distance into opening 535. In alternative embodiments, it is appreciated that ribs 536 and grooves 348 can be replaced with alternative interlocking shapes and structures and that other interlocking mechanisms can also be used. However, the current assembly simplifies production assembly.

Further assembly entails nesting outer knob 462 onto collar 460. Specifically, floor 522 is received within opening 468 of collar 460 from the distal side thereof while flange 533 is disposed adjacent to distal side 477 of collar 460. Outer knob 462 can be positioned so that at least a portion of sleeve segment 512 is disposed between floor 522 and collar 460. A seal 540 is disposed between outer knob 462 and collar 460. In this assembly state, as shown in FIG. 12, rotation of outer knob 462 relative to collar 460 facilitates concurrent rotation of control shaft 334, which as previously discussed, facilities select rotation of orifice plate 370 relative to control plate 356 (FIG. 14).

Returning to FIG. 16, inner knob 464 comprises a body 542 typically having a circular perimeter edge 544 that extends between a proximal face 546 and an opposing distal face 548. One or more grips 550 outwardly project from distal face 548. A mounting hole 552 centrally passes through body 542 between opposing faces 546 and 548. As previously discussed, during assembly enlarged head 328 of inner shaft 312 is threadedly received within recess 344 of enlarged head 343 of control shaft 334. In turn, inner knob 464 is rotatably received within recess 532 of outer knob 462 and fastener 554 is passed through mounting hole 552 and threaded into mounting hole 331 on inner shaft 312, thereby rotatably securing both inner knob 464 and outer knob 462 to the remainder of damper 10B. In this assembled configuration, rotation of inner knob 464, such as be gripping and rotating grip 550, results in the rotation of inner shaft 312. Because inner shaft 312 is threadedly coupled to control shaft 334, the rotation of inner shaft 312 causes inner shaft 312 to advance proximally or retract distally relative to control shaft 334 which in turn causes nose portion 318 to selectively restrict or open inlet opening 56 on boundary 30B (FIG. 11) so as to selectively adjust damping during the compression stroke of piston rod assembly 126.

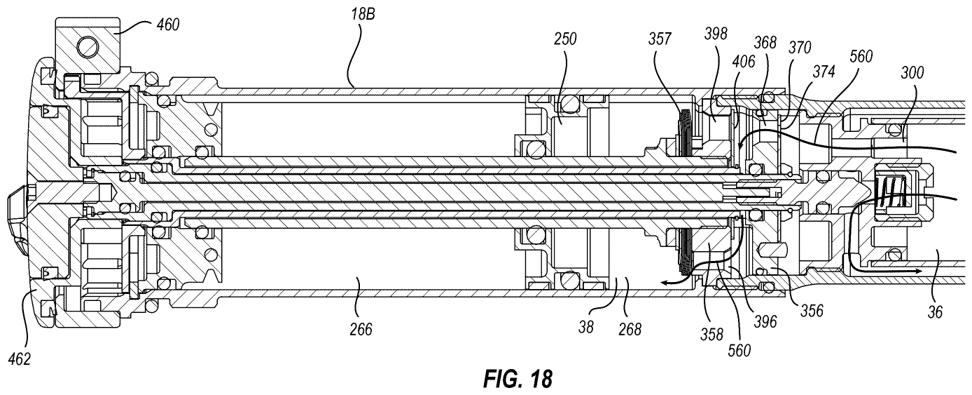

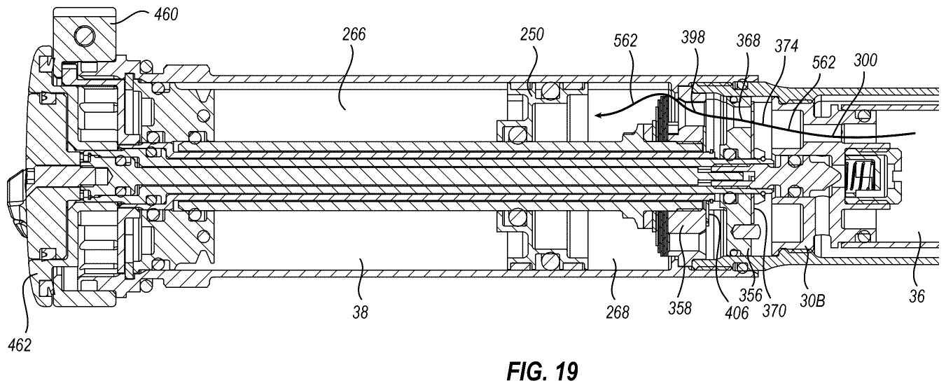

Given the foregoing components and assembly of damper 10B, damper 10B has additional damping controls relative to damper 10. For example, damper 10B can be adjusted between a sprint mode, as shown in FIG. 18, and a compression mode, as shown in FIG. 19. With reference to FIG. 18, in the sprint mode, it is desired to maximize damping produced by damper 10B so that a minimum amount of the energy input to move a related vehicle, such as a bicycle, is appreciated by the limited movement of damper 10B, i.e., the applied energy is more efficiently used to move the vehicle. To move damper 10B into the sprint mode, cable 496 (FIG. 12) is manipulated so that blocking plate 406 is moved to the closed position so as to close fluid passage 398 of regulating plate 358. In this configuration, as piston rod assembly 126 is moved distally within primary chamber 36 in a compression stroke, at least part of the hydraulic fluid flows, as shown by arrows 560, from primary chamber 36, through fluid passage 300 on boundary 30B, and through aligned orifice 374 of orifice plate 370 and control passage 368 of control plate 356. Because fluid passage 398 of regulating plate 358 is closed, the fluid then flows through each of regulating passages 396 of regulating plate 358 and into secondary chamber 38/proximal secondary compartment 268 distal of regulating plate 358. For the hydraulic fluid to pass through regulating passages 396, sufficient fluid pressure must be applied to outwardly flex shim assembly 357 that is covering the distal outlet of regulating passages 396. The required fluid pressure needed to flex shim assembly 357 limits or restricts the ability of piston rod assembly 126 to move distally along the compression stroke, thereby increasing damping of damper 10B (limiting distal movement of piston rod assembly 126) so that more energy is directed towards movement of the vehicle, rather than having energy absorbed/lost by excessive suspension movement of piston rod assembly 126.

Fine tuning of this damping is achieved by rotating outer knob 462 so as to rotate orifice plate 370 relative to control plate 356. Specifically, aligning larger orifices 374 on orifice plate 370 with control passage 368 allows hydraulic fluid to more freely flow through control passage 368, i.e., less damping, while aligning smaller orifices 374 on orifice plate 370 with control passage 368 results in a more restricted flow of hydraulic fluid through control passage 368, i.e., more damping.

With reference to FIG. 19, to move damper 10B from the sprint mode to the compression mode, cable 496 (FIG. 12) is again manipulated so that blocking plate 406 is moved to the open position so as to open or unblock fluid passage 398 of regulating plate 358. In this configuration, as piston rod assembly 126 is moved distally within primary chamber 36 in a compression stroke, at least part of the hydraulic fluid flows, as shown by arrows 562, from primary chamber 36, through fluid passage 300 on boundary 30B, and through aligned orifice 374 of orifice plate 370 and control passage 368 of control plate 356. The hydraulic fluid then freely flows through open fluid passage 398 and into proximal secondary compartment 268 distal of regulating plate 358. Because no flexing of shim assembly 357 is required, piston rod assembly 126 can move distally more freely along the compression stroke and thereby decreases damping produced by damper 10B, i.e., more applied energy is dissipated through the damping. In this compression mode, fine tuning of the damping can again be achieved by rotating outer knob 462 so that the desired orifice 374 of orifice plate 370 is aligned with control passage 368 of control plate 356. Further damping can also be adjusted by turning adjuster inner knob 464 to advance or retract compression metering needle 70B, as discussed above, to adjust damping values to a 0-50 inches per second (ips) (0-127 cm/second) range and by adjusting of piston rod assembly 126 as previously discussed above with regard to damper 10.

Whether in the sprint mode or the compression mode, as piston rod assembly 126 is moved proximally along the rebound stroke, the hydraulic fluid within proximal secondary compartment 268 flows proximally through fluid passage 398 of regulating plate 358, through control passage 368 of control plate 356, and through fluid passage 300 of boundary 30B. If blocking plate 406 is in the blocking position so as to cover the opening to fluid passage 398 (sprint mode), blocking plate 406 is configured to flex proximally so as to allow the hydraulic fluid to flow proximally through fluid passage 398 with minimal restriction. In this way, blocking plate 406 also functions as a check valve. Likewise, orifice plate 370 is also configured to flex proximally to allow the hydraulic fluid to flow proximally through control passage 368 with minimal restriction. As a result, piston rod assembly 126 can rebound with minimal restraint from regulating plate 358, control plate 356, or boundary 30B.

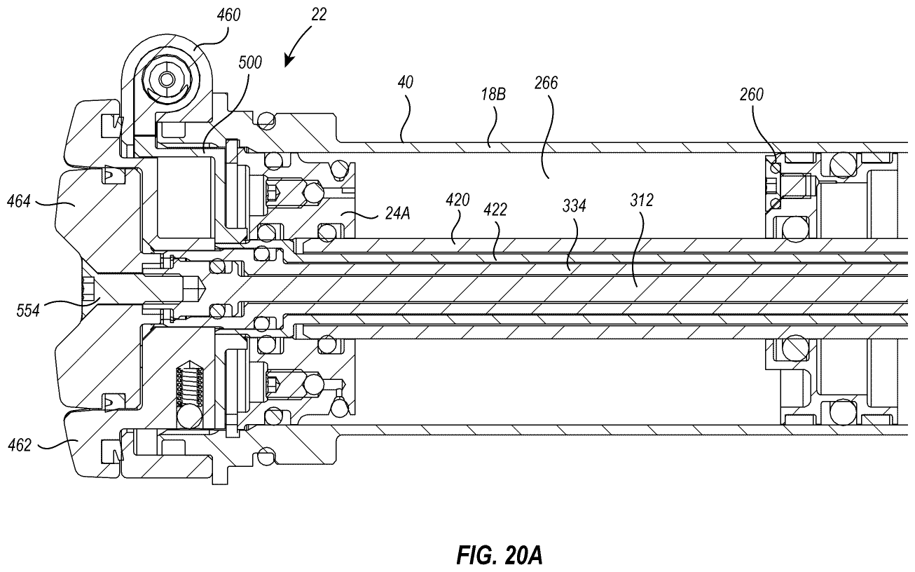

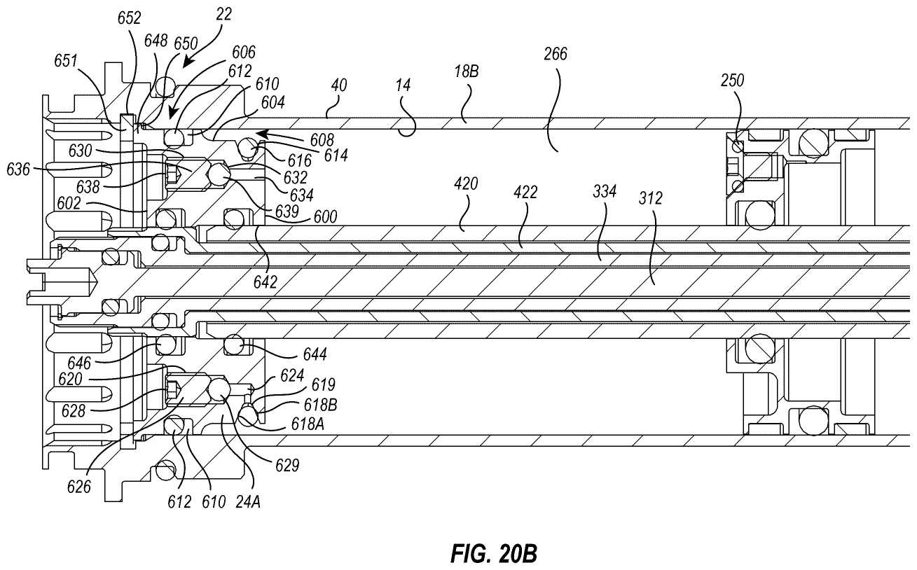

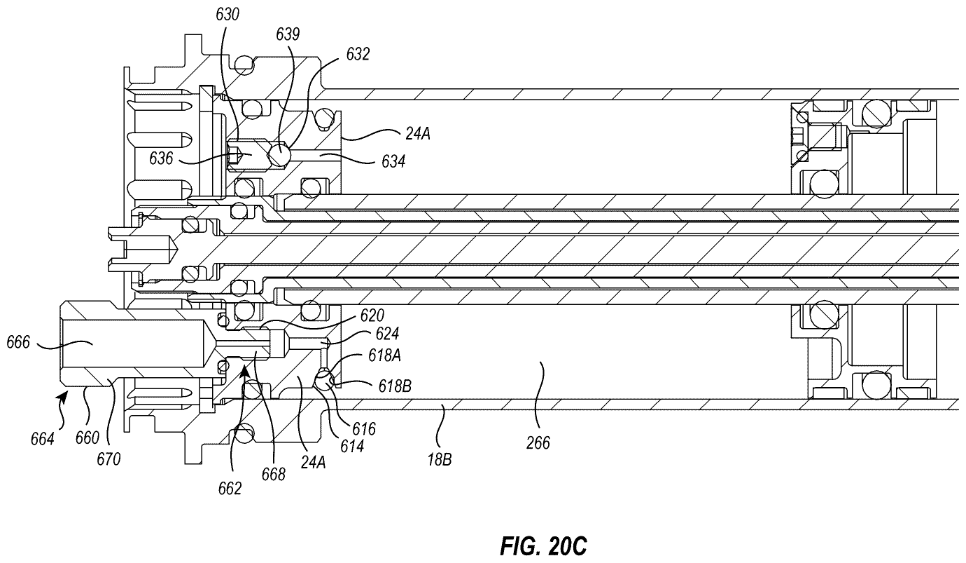

With reference to FIGS. 20A and 20B and as previously discussed, distal secondary compartment 266 can be filled with a gas to help control the movement of floating piston 250. In the depicted embodiment, the gas can be selectively passed into and removed from distal secondary compartment 266 through distal end wall 24A. Distal end wall 24A is removably received within sidewall 18B/secondary sidewall portion 40 at distal end 22 and includes an interior face 600 facing distal secondary compartment 266 and an opposing exterior face 602 with an encircling outer side face 604 extending therebetween. Outer side face 604 includes an encircling distal portion 606 extending from exterior face 602 that is disposed adjacent to interior surface 14 of sidewall 18B and an encircling proximal portion 608 extending from interior face 600 and that is radially spaced inward from interior surface 14 of sidewall 18B. An annular groove 610 is recessed within distal portion 606 and receives a seal 612, such as an O-ring, that forms a liquid tight seal between end wall 24A and sidewall 18B. As will be discussed below in greater detail, an annular notch 614 is recessed on proximal portion 608 and has an elastomeric ring 616, such as an O-ring, received therein. Notch 614 is bound by opposing tapered faces 618A and 618B that converge toward a bottom 619 of notch 614. Tapered faces 618A and 618B are typically planar and can have a V-shaped configuration. Elastomeric ring 616 is configured so as to resiliently urge against both of tapered faces 618A and 618B so as to form a gas tight seal thereagainst.

End wall 24A also includes a threaded first inlet 620 recessed into exterior face 602 and terminating at a floor 622. Floor 622 is typically tapered, such as by having a conical or frustoconical configuration. A first gas passage 624 extends from floor 622 of first inlet 620 to bottom 619 of notch 614. Because of the orientation of first inlet 620 and notch 614, first gas passage 624 is typically L-shaped. However, other configurations can also be used. A set screw 626 is removably threaded into first inlet 620 and has an exposed recess 628, such as a socket or slot, for receiving a driver, such as an Allen wrench, screwdriver, or other complementary engaging tool. In one embodiment, recess 628 comprises a polygonal socket configured to receive an Allen wrench. A ball 629 is disposed within first inlet 620 between set screw 626 and floor 622. Ball 629 is configured so that when set screw 626 is advanced into first inlet 620, ball 629 is pressed and sealed against tapered floor 622 so as to seal first gas passage 624 closed thereat.

End wall 24A also includes a threaded second inlet 630 spaced apart from first inlet 620. Second inlet 630 is recessed into exterior face 602 and terminates at a floor 632. Floor 632 is typically tapered such as by having a conical or frustoconical configuration. A second gas passage 634 extends from floor 632 to interior face 600. Second gas passage 634 can be linear or have other configurations. A set screw 636 is removably threaded into second inlet 630 and has an exposed recess 638, such as a socket or slot, for receiving a driver, such as an Allen wrench, screwdriver, or other complementary engaging tool. In one embodiment, recess 638 comprises a polygonal socket configured to receive an Allen wrench. A ball 639 is disposed within second inlet 630 between set screw 636 and floor 632. Ball 639 is configured so that when set screw 636 is advanced into second inlet 630, ball 639 is pressed and sealed against tapered floor 632 so as to seal second gas passage 634 closed thereat.

End wall 24A also includes a central passage 642 that centrally passes though end wall 24A from interior face 600 to exterior face 602. Inner shaft 312, control shaft 334, regulating shaft 422, outer shaft 420 are disposed within central passage 642 so as to encircled by end wall 24A. Annular seals 644 and 646 are disposed within annular recesses formed on an annular surface encircling central passage 642 and provide a seal between end wall 24A and outer shaft 420 and a seal between end wall 24A and regulating shaft 422, respectively.

An annular lip 648 radially outwardly projects from outer side face 604 at a distal end of end wall 24A. During assembly, end wall 24A is received within sidewall 18B until annual lip 648 is received within an annular groove 650 on interior surface 14, thereby stopping further advancing of end wall 24A within sidewall 18B. A resiliently flexible C-clip 651 is then received within an annular slot 652 recessed on interior surface 14 of sidewall 18B distal of end wall 24A. C-clip 651 is sized to prevent or restrict end wall 24A from sliding distally when C-clip 651 is received within annular slot 652.

As depicted in FIG. 20A, initially, during use, end wall 24A is secured within sidewall 18B, as discussed above, while inner knob 464, outer knob 462, collar 460, and pinion assembly 500 are secured to one of regulating shaft 422, control shaft 334 or inner shaft 312, as previously discussed. When it is desired to add or remove gas from distal secondary compartment 266, fastener 554 is removed which enables inner knob 464, outer knob 462, collar 460, and pinion assembly 500 to be removed from the corresponding shafts by sliding distally, as shown in FIG. 20B. To add gas to distal secondary compartment 266, set screw 626 and ball 629 are manually removed from first inlet 620. Turning to FIG. 20C, a tubular stem 660 and then threaded into first inlet 620. Specifically, stem 660 has a first end 662 and an opposing second end 664 with a channel 666 extending through stem 660 between opposing ends 662 and 664. A radially constricted first stem portion 668 is formed at first end 662 and has threads formed on the exterior surface thereof. First stem portion 668 is configured to be threaded into first inlet 620 by rotation of stem 660. A radially enlarged second stem portion 670 is disposed at second end 664. Second stem portion 670 is either configured to be coupled with a gas line, such as by having threads or another coupling formed thereon, or is integrally formed with a gas line. The gas line is coupled with a gas source such as a pump, container of compressed gas, or other gas source.

Gas is dispensed into distal secondary compartment 266 by passing gas through the gas line, through stem 660 and through first gas passage 624. The gas is sufficiently pressured so that as the gas passes through first gas passage 624, the gas pushes elastomeric ring 616 radially outward so that the gas can flow around elastomeric ring 616 and into distal secondary compartment 266. Once the gas flow is stopped, elastomeric ring 616 automatically resiliently rebounds back into annular notch 614 so as to seal against opposing faces 618A and B, thereby preventing the gas within distal secondary compartment 266 from escaping back out through first gas passage 624. To release any excess gas from distal secondary compartment 266, set screw 636 is loosened which allows ball 639 to move distally away from floor 632. Gas can then freely flow from distal secondary compartment 266, through second gas passage 634, around ball 639, around set screw 636 and out of second inlet 630. The gas flow is stopped by again advancing set screw 636 into second inlet 630 until ball 639 seals against floor 632. Once the desired gas pressure is reached within distal secondary compartment 266, set screw 626 and ball 629 are again replaced within first inlet 620 so as to further seal first gas passage 624 closed. Inner knob 464, outer knob 462, collar 460, and pinion assembly 500 are then replaced as shown in FIG. 20A.

Gas is typically provided to distal secondary compartment 266 through an end wall so that there is no interference by floating piston 250. The above design provides a novel configuration for dispensing gas into and removing gas from distal secondary compartment 266 through end wall 24A where the distal end face of end wall 24A is covered by rotatable knobs. The above design also enables end wall 24A to have a low profile and eliminates the use of conventional gas valves that can potentially be damaged or clogged during operation of the damper. Other benefits also exist. It is appreciated that the disclosed suspension dampers can also have a variety of other configurations. For example, in contrast to having a gas within distal secondary compartment 266, the gas can be replaced with a spring or other resiliently flexible member that is disposed against floating piston 250. As the hydraulic fluid flows into proximal secondary compartment 268 so as to move floating piston 250, the resiliently flexible member is resiliently compressed, thereby providing an urging force against floating piston 250 and thus increasing the fluid pressure of the hydraulic fluid. Further details and other alternatives for replacing the gas with a resiliently flexible member are disclosed in U.S. Pat. No. 6,978,872, which was previously incorporated herein by specific reference.

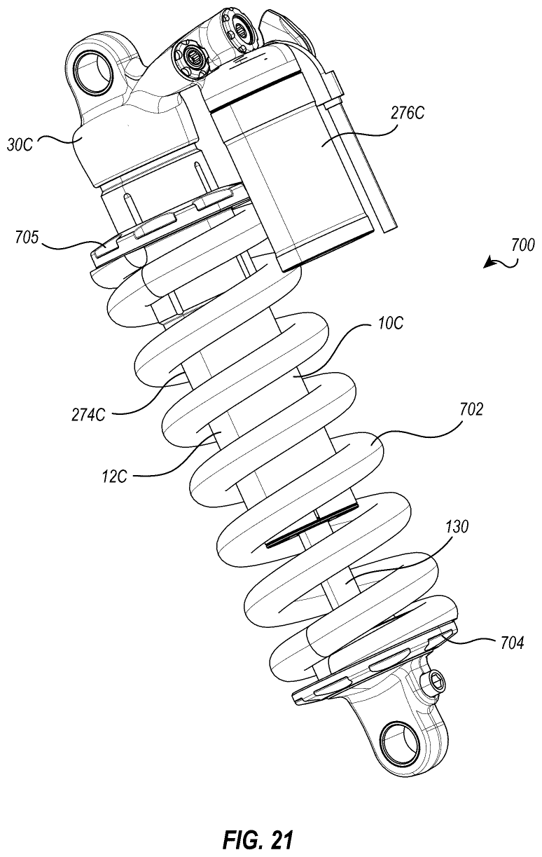

Depicted in FIG. 21 is one embodiment of a shock absorber 700 that incorporates another alternative embodiment of a suspension damper 10C incorporating features of the present disclosure. Like elements between damper 10C and the prior dampers disclosed herein are identified by like reference numbers. Furthermore, the disclosure and alternatives discussed above with regard to the prior dampers are also applicable to like elements of damper 10C, unless indicated otherwise.

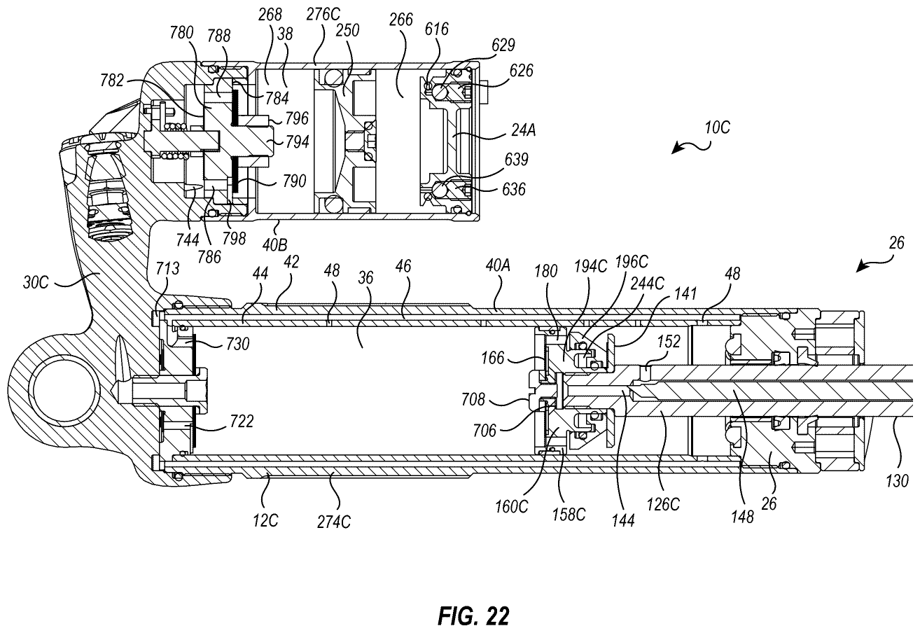

In general, shock absorber 700 comprises damper 10C having a spring 702 mounted thereon. With reference to FIGS. 21 and 22, damper 10C has a piggy-back configuration and generally includes a housing 12C that comprises a primary housing 274C bounding primary chamber 36 and a secondary housing 276C bounding secondary chamber 38. A boundary 30C extends between primary housing 274C and secondary housing 276C. As discussed below in further detail, boundary 30C bounds a pressure control passage 703 that extends between primary chamber 36 and secondary chamber 38 and allows hydraulic fluid to pass therebetween. Primary housing 274C includes primary sidewall portion 40A that includes outer sidewall 42 and inwardly disposed inner sidewall 44 that both extend between proximal end wall 26 and boundary 30C. Proximal end wall 26 is depicted in this embodiment as a cap or insert that is threaded into the proximal end of primary housing 274C. Other configurations can also be used. Bypass channel 46 is disposed between outer sidewall 42 and inner sidewall 44 with longitudinally spaced ports 48 passing through inner sidewall 44 so as to provide fluid communication between bypass channel 46 and primary chamber 36. Secondary housing 276C includes secondary sidewall portion 40B extending between distal end wall 24A and boundary 30C. Distal end wall 24A is depicted in this embodiment as a cap or insert that is threaded into the distal end of secondary housing 276C. Other configurations can also be used. As with damper 10A, in damper 10C primary housing 274C and secondary housing 276C are laterally spaced apart and can each have a central longitudinal axis that can be disposed in parallel alignment to each other. In alternative embodiments, primary housing 274C and secondary housing 276C can be configured or orientated so that the central longitudinal axes thereof are not parallel but can be at any desired angular orientation. Floating piston 250 is slidably disposed within secondary chamber 38 and divides secondary chamber 38 into distal secondary compartment 266 and proximal secondary compartment 268. Again, a gas is disposed within distal secondary compartment 266. The gas can be added or removed from secondary compartment 266 such as by being passed through passages extending through end wall 24A that are selectively blocked by set screws 626 and 636. This is accomplished in the same manner as previously discussed with regard to the embodiment shown in FIGS. 20A-20C. Alternatively, a Schrader valve or other gas valve can be mounted on secondary housing 276C. A hydraulic fluid is disposed within proximal secondary compartment 268 and primary chamber 36.

A piston rod assembly 126C is slidably disposed within primary chamber 36 and can have the same components and alternatives as the other piston rod assemblies disclosed herein. In the depicted embodiment, piston rod assembly 126C includes piston rod 130 having rebound metering needle 148 movably disposed within channel 144 thereof. Piston rod assembly 126C also includes flange 141 radially outwardly projecting at the distal end of piston rod 130, a control valve 196C encircling piston rod 130 distal of flange 141, and a valve guide 194C encircling piston rod 130 distal of control valve 196C. Control valve 196C and valve guide 194C combine to form a control valve assembly 160C that bounds an adjustable, sealed valve compartment 244C therebetween. A main piston 158C is seated on valve guide 194C and is slidably sealed against the interior surface inner of sidewall 44. Main piston 158C includes a plurality of compression ports 180 passing therethrough that are aligned with control valve 196C and central ports 706 that centrally pass therethrough and communicate with channel 144. Shim assembly 166 is disposed against the distal face of main piston 158C so as to cover central ports 706. A fastener 708 centrally secures shim assembly 166 of main piston 158C.

It is noted in this embodiment that previously discussed spring 162 is not required extending between control valve 196C and main piston 158C but may be incorporated. Spring 702 shown in FIG. 21 has a proximal end secured by a retainer 704 disposed on the proximal end of piston rod 130 and an opposing distal end secured by a retainer 705 disposed on primary housing 274C. As such, spring 702 is resiliently compressed as piston rod assembly 126C is advanced within primary chamber 36 during a compression stroke. In the depicted embodiment, spring 702 comprises a coiled spring. Other non-coiled spring configurations can also be use. In yet other embodiments, shock absorber 700 can be modified to replace coiled spring 702 with an air spring. One example of an air spring that can be incorporated into shock absorber 700 is disclosed in U.S. Pat. No. 6,135,434, granted Oct. 24, 2000, which is incorporated herein by specific reference.

Piston rod assembly 126C functions to facilitate damping in substantially the same way as previously discussed with regard to piston rod assembly 126. For example, as piston rod assembly 126C is advanced distally within primary chamber 36 during a compression stroke, the hydraulic fluid passes proximally through compression ports 180 while control valve 196C initially moves proximally relative to valve guide 194C. As more of piston rod assembly 126C enters primary chamber 36, the fluid pressure therein increases so as to cause control valve 196C to progressively move distally, thereby restricting fluid flow through compression ports 180 until compression ports 180 are closed and advancement of piston rod assembly 126C is stopped. As piston rod assembly 126C moves distally along the rebound stroke due to spring 702 (FIG. 21), hydraulic fluid flows through port 152, along channel 144, and out through ports 706 by distally flexing shim assembly 166.

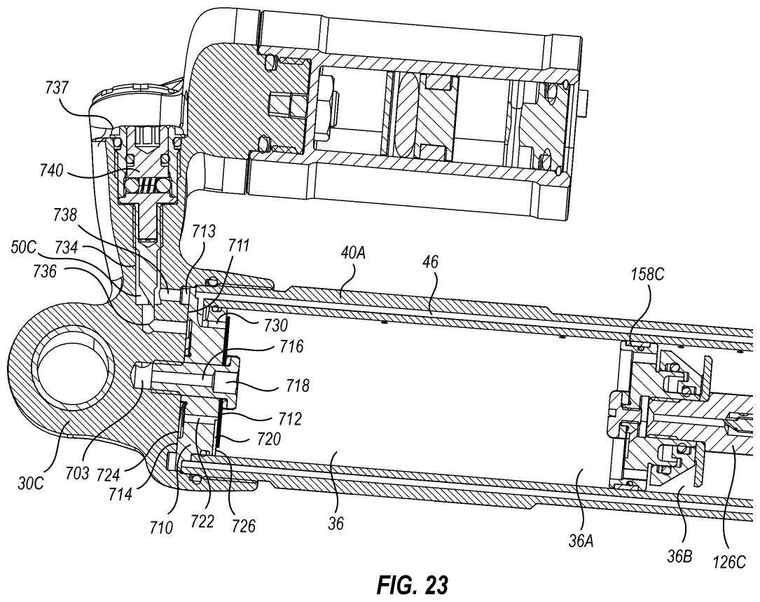

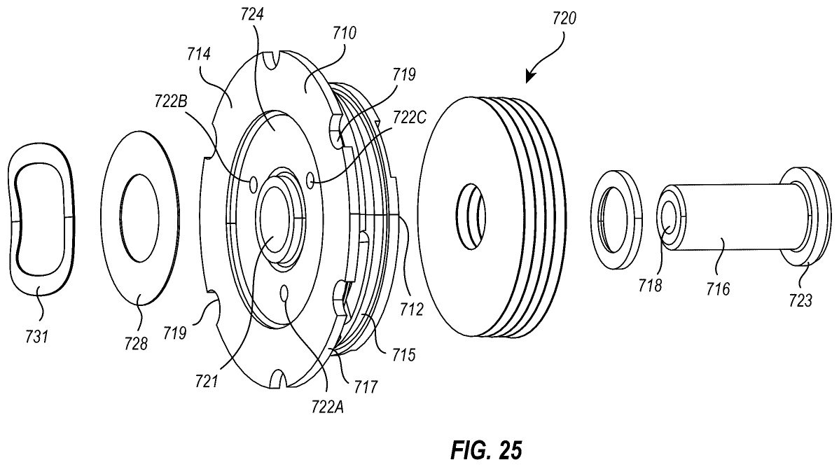

Turing to FIGS. 23-25, disposed within primary chamber 36 adjacent to an end face 711 of boundary 30C is an insert 710. Insert 710 has a proximal face 712, an opposing distal face 714, and a side face 715 extending therebetween. An annular lip 717 radially outwardly projects from side face 715 adjacent to distal face 714. A plurality of radially spaced apart notches 719 pass through annular lip 717 to communicate with side face 715. An annular groove 713 is recessed into end face 711 of boundary 30C. Groove 713 is formed at an outer perimeter of end face 711 and aligns with annular lip 717 when insert 710 is secured against boundary 30C. As a result, fluid flowing through annular groove 713 communicates with and flows through notches 719 of annular lip 717.

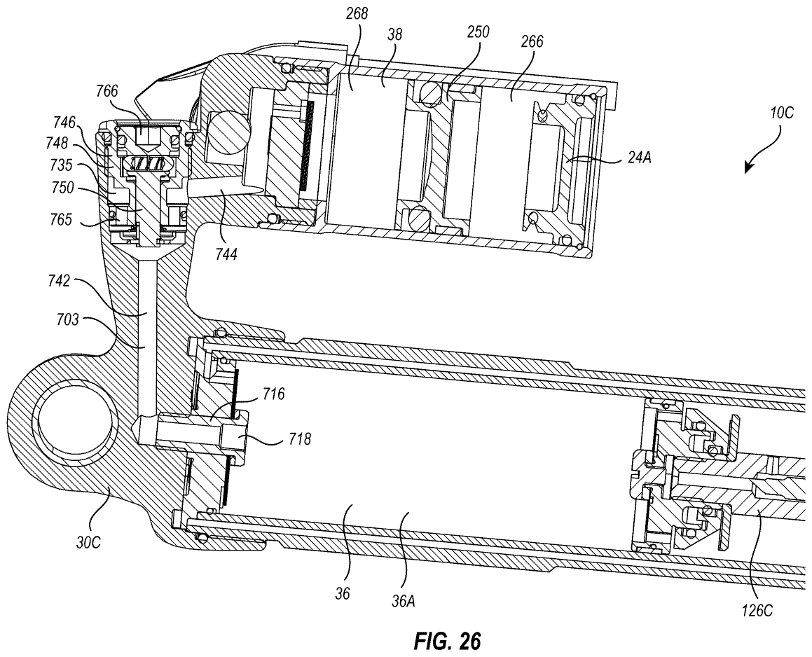

A central passage 721 centrally passes through insert 710 from proximal face 712 to distal face 714. A tubular fastener 716 having an enlarged head 723 is passed through central passage 721of insert 710 and is secured to boundary 30C, such as by threaded connection, press-fit connection, or the like. A channel 718 passes through the length of fastener 716 and provides fluid communication between primary chamber 36 and pressure control passage 703 (FIG. 26) passing through boundary 30C. Fastener 716 also passes through and secures a flexible shim assembly 720 directly against proximal face 712 of insert 710. As with the other shim assemblies disclosed herein, shim assembly 720 can comprise one, two, three or more flexible, stacked shims 725. In one embodiment, each shim 725 can be annular. Other shapes can also be used.

A plurality of radially spaced apart receiving channels 722A-C also pass through insert 710 from proximal face 712 to distal face 714. Each receiving channel 722A-C fluid couples with a collection channel 724 recessed on distal face 714. In the assembled state, collection channel 724 is bound between insert 710 and boundary 30C. In one embodiment, collection channel 724 encircles fastener 716/passage 721 and can be annular or have other configurations. Disposed within collection channel 724 is a washer 728 that encircles fastener 716/passage 721. Washer 728 is typically circular, although other shapes can also be used, and is configured to cover the distal opening of receiving channels 722A-C where they communicate with collection channel 724. Disposed on the distal side of washer 728 is a curved and resiliently flexible spring washer 731. In the assembled state, spring washer 731 is captured within collection channel 724 and is partially compressed to urge washer 728 against the distal openings of receiving channels 722A-C, thereby blocking the distal openings. As discussed below, spring washer 731 and washer 728 work together to form a one-way check valve so as to only let fluid flow one direction through receiving channels 722A-C.

In the depicted embodiment, the proximal opening of each receiving channel 722A-C is covered or overlayed by shim assembly 720. However, radially spaced apart recesses 726A-C are recessed on proximal face 712 and extend from a corresponding receiving channel 722A-C to side face 715 of insert 710. Side face 715 is radially spaced apart from the other perimeter edge of shim assembly 720. As such, hydraulic fluid can freely flow around shim assembly 720 and along each recess 726A-C to a corresponding receiving channel 722A-C.

Insert 710 also includes return channels 730A-730C each having a proximal opening formed on proximal face 712 and a distal opening formed on side face 715. As discussed below in more detail, the proximal openings of return channels 730A-730C are covered by shim assembly 720 which functions as a one-way check valve to limit the flow of fluid through return channels 730A-730C. In the assembled state, the distal openings of return channels 730A-C communicate with both the distal opening of bypass channel 46 and also groove 713.

With continued reference to FIG. 23, bound within boundary 30C is a first cavity 734, having an opening 737 formed on an exterior surface of boundary 30C, a receiving passage 736 that extends from collection channel 724 to first cavity 734, and a return passage 738 that extends from first cavity 734 to annular groove 713 recessed into end face 711 of boundary 30C. First cavity 734, receiving passage 736, and return passage 738 combine to form a transfer passage 50C that, as discussed below in more detail, extends at least partially between primary chamber 36 and bypass channel 46 and that can communicate with primary chamber 36 and bypass channel 46. A compression metering needle 740 is movably disposed within first cavity 734 and is used to regulate the flow rate of fluid along transfer passage 50C, i.e., between receiving passage 736 and return passage 738. For example, compression metering needle 740 can be threaded into first cavity 734 and can have a tip that selectively constricts or opens receiving passage 736, return passage 738, and/or first cavity therebetween so as to control the fluid flow rate by threadedly advancing compression metering needle 740 into or out of first cavity 734.

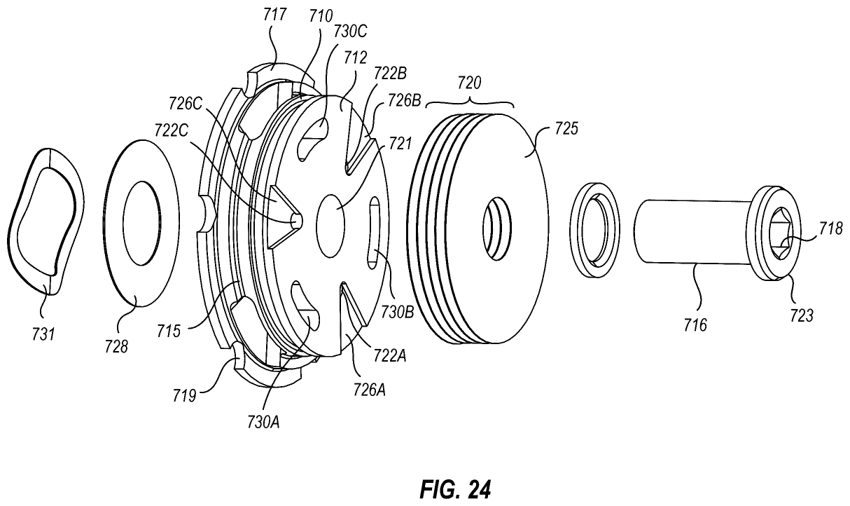

When in the assembled state during use, as piston rod assembly 126C is advanced distally within primary chamber 36 during a compression stroke, the hydraulic fluid within primary chamber 36 flows around shim assembly 720, along recesses 726, through receiving channels 722, and pushes against washer 728 to at least partially compress spring washer 731 (FIG. 24) so that the hydraulic fluid flows into collection channel 724. The hydraulic fluid then flows through receiving passage 736 and into return passage 738 by flowing through a portion of first cavity 734. The permitted flow rate of the hydraulic fluid is dependent in part on the position of compression metering needle 740. Next, the hydraulic fluid flows around annular groove 713, through notches 719 in lip 717 (FIG. 24) and finally into bypass channel 46. The hydraulic fluid flows down the length of bypass channel 46 and flows back into primary chamber 36 proximal of main piston 158C by flowing through one or more of bypass ports 48 disposed proximal of main piston 158C (FIG. 22). It is noted that shim assembly 720 prevents hydraulic fluid from flowing directly from primary chamber 36 into return channels 730 during the compression stroke.

In contrast, as piston rod assembly 126 moves proximally within primary chamber 36 during a rebound stroke, the hydraulic fluid within primary chamber 36 proximal of main piston 158C flows into bypass channel 46 through bypass ports 48 proximal of main piston 158C, flows distally along bypass channel 46, and returns into primary chamber 36 by either flowing through bypass ports 46 distal of main piston 158C and/or by flowing through the distal end of bypass channel 46, into the distal opening of return channels 730, and finally out through the proximal opening of return channels 730 by proximally flexing shim assembly 720 so that the hydraulic fluid can flow around shim assembly 720 and back into primary chamber 36. Hydraulic fluid is precluded from flowing back out through receiving channels 722 and into primary chamber 36 as a result of the distal end of receiving channels 722 being blocked by washer 728 and spring washer 731. It is appreciated that the above discussed operation of bypass channel 46 with compression metering needle 740 and insert 710 achieves substantially the same damping as previously discussed with regard to bypass channel 46 with compression metering needle 70 and boundary 30 of damper 10.

As discussed above with regard to damper 10B, the damping properties of damper 10C can also be adjusted by switching between a sprint mode and a compression mode. Specifically, with reference to FIG. 26, boundary 30C also bounds a second cavity 735 that opens to the exterior surface of boundary 30C. A first fluid passage 742 extends through boundary 30C having a first end communicating with primary chamber 36 through channel 718 of fastener 716 and an opposing second end communicating with second cavity 735. A second fluid passage 744 also extends through boundary 30C having a first end communicating with second cavity 735 and an opposing second end communicating with secondary chamber 38. First fluid passage 742, second fluid passage 744 and second cavity 735 combine to form previously discussed pressure control passage 703 which can also be referred to as a fluid passage.

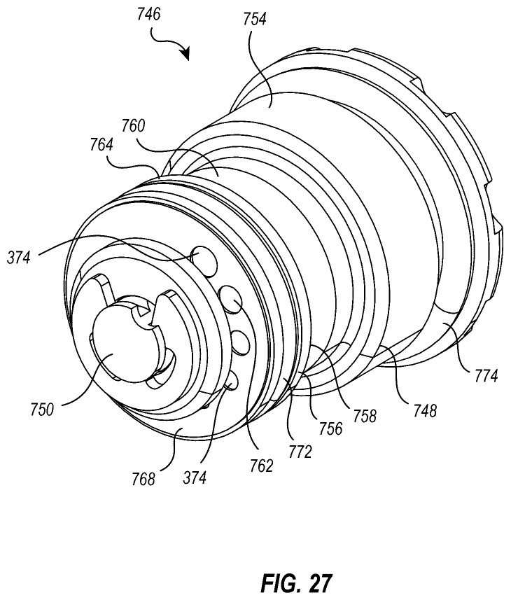

Disposed within second cavity 735 is a regulating valve 746. With reference to FIGS. 26 and 27, regulating valve 746 includes a valve body 748 that encircles a rotatable control shaft 750. Valve body 748 includes an enlarged main body 754 disposed at a distal end that communicates with the exterior surface of boundary 30C, an annular control plate 756 disposed at an opposing proximal end, and a constricted stem 758 that extends therebetween. An annular grooved recess 760 encircles stem 758 and is bound between main body 754 and control plate 756. Control plate 756 has a proximal face 762 and an opposing distal face 764 with a control passage 765 extending therebetween so that control passage 765 communicates with grooved recess 760.

Control shaft 750 passes through and is rotatably disposed within valve body 748. Control shaft 750 has a distal end that openly communicates with the exterior of boundary 30C so that the distal end is openly exposed. An engaging surface 766 is formed on the distal end for selective engaging and rotating control shaft 750. In the depicted embodiment, engaging surface 766 is shown as a polygonal socket which can be engaged by an Allen wrench. Other configurations can also be used.

Rotatably mounted flush against proximal face 762 of control plate 756 is an orifice plate 768, similar to previously discussed orifice plate 370. Orifice plate 768 has a central shaft port extending therethrough through, which control shaft 750 passes, and a plurality of different sized orifices 374 extending therethrough. Orifices 374 are radially spaced apart and are positioned so that as orifice plate 768 is rotated relative to control plate 756, orifices 374 consecutively align with control passage 765. Orifices 374 are typically formed to progressively increase or decrease in size in consecutive order with the largest orifice 374 being the same size or smaller than control passage 765. Control passage 765 and orifices 374 typically have a circular transverse cross section but other shapes, such as polygonal, can also be used. The number of orifices 374 can vary based on intended use and the desired level of damping adjusting. In one embodiment, the number of orifices 374 can comprise at least two, three, four, five, six, or eight or be in a range between any two of the foregoing. The proximal end of control shaft 750 is securely fixed to orifice plate 768 so that rotation of control shaft 750 facilitates rotation of orifice plate 768 relative to control plate 756.

Regulating valve 746 also includes an annular seal 772 that encircles around the outer perimeter of control plate 756 and seals against the interior surface of second cavity 735, proximal of second fluid passage 744. Likewise, an annular seal 774 encircles around the outer perimeter of valve body 748 and seals against the interior surface of second cavity 735, distal of second fluid passage 744. As such, hydraulic fluid entering second cavity 735 from first fluid passage 742 is forced to travel through control passage 765 of control plate 756 with an aligned orifice 374 and into grooved recess 760. In turn, because of the sealed engagement caused by second seal 774, the hydraulic fluid flowing into grooved recess 760 is now forced to flow along second fluid passage 744 toward secondary chamber 38.

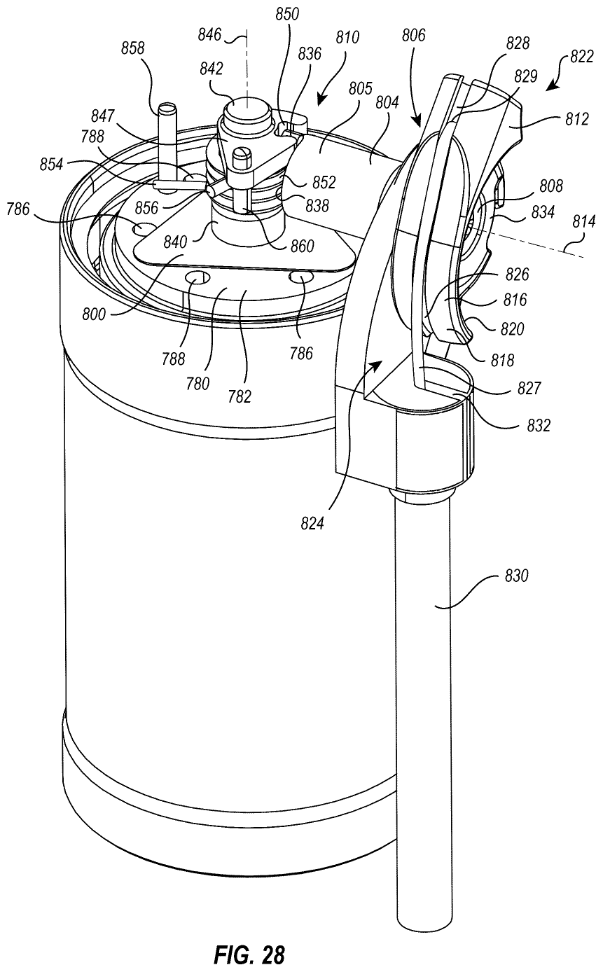

With reference to FIGS. 22 and 28, disposed within the proximal end of secondary chamber 38 so as to laterally span across secondary chamber 38 is a regulating plate 780 that is similar to previously discussed regulating plate 358. Regulating plate 780 has a proximal side face 782 that communicates with second fluid passage 744 and an opposing distal side face 784. A plurality of radially spaced apart fluid passages 786 pass through regulating plate 780 between side faces 782 and 784 and a plurality of radially spaced apart regulating passages 788 pass through regulating plate 780 between side faces 782 and 784. A shim assembly 790 is mounted against distal side face 784 of regulating plate 780 so as to cover the distal opening of each regulating passage 788. As such, shim assembly 790 functions as a one-way check valve and must be flexed distally to allow hydraulic fluid to pass through regulating passages 788. Shim assembly 790 can comprise one, two, three or more flexible stacked shims. In one embodiment, each shim can be annular. Other shapes can also be used. In one embodiment, shim assembly 790 encircles a stem 794 centrally extending from distal side face 784 of regulating plate 780. A fastener 796, such as a threaded nut, is secured to stem 794 and secures shim assembly 790 against distal side face 784. Other mounting mechanisms can also be use.

In the depicted embodiment shim assembly 790 at least partially overlays the distal opening to each fluid passage 786. However, a recess 798 is formed on distal side face 784 that extends radially outward from each fluid passage 786 to the outer perimeter edge of regulating plate 780 or at least past the outer perimeter edge of shim assembly 790. As such, hydraulic fluid can freely flow through regulating plate 780 unconstrained by shim assembly 790.

Rotatably mounted flush against proximal side face 782 of regulating plate 780 is a blocking plate 800. Blocking plate 800 is selectively rotatable between an open position wherein the proximal opening of each fluid passage 786 is openly exposed so that fluid can freely flow through fluid passages 786 and a closed position wherein blocking plate 800 is rotated to cover proximal opening of the fluid passage 786. In both the open position and the closed position, the proximal opening of each regulating passage 788 remains openly exposed. As such, when regulating plate 780 is in the closed position blocking fluid passages 786, hydraulic fluid is prevented from flowing distally through fluid passages 786 and is forced to flow distally through regulating passages 788 by distally flexing shim assembly 790. In the depicted embodiment, blocking plate 800 has a triangular configuration to selectively block fluid passages 786 without blocking regulating passages 788. However, other configurations can also be used.

A mechanism is also provided for selectively rotating blocking plate 800 between the open and closed position. In one embodiment the mechanism comprises a first spindle 804 rotatably disposed within secondary chamber 38 proximal of blocking plate 800. First spindle 804 comprises a first spindle body 805 having a first end 806 rotatably secured to boundary 30C by a fastener 808 and an opposing second end 810 that projects laterally into secondary chamber 38 and terminates at a terminal end face 838. Fastener 808 also secures a cable mount 812 to first end 806 of first spindle 804/first spindle body 805 such that the pivoting of cable mount 812 facilitates rotation of first spindle 804 about a rotational axis 814. Cable mount 812 includes an elongated arm 816 having a front face 818 and an opposing back face 820 that each extend between a first end 822 and an opposing second end 824. Arm 816 curves along the length thereof from first end 822 to second end 824. A slot 826 is recessed along the length of front face 818 and is configured to receive a cable 827. Slot 826 communicates with a pocket 828 disposed at first end of arm 816. Pocket 828 is configured to capture an enlarged head 829 located at a first end of cable 827 so as to secure cable 827 to arm 816. An optional tubular guide 830 can be secured to boundary 30C so as to project distal of arm 816. Tubular guide 830 bounds a channel 832 extending along the length thereof that receives and covers cable 827 extending from arm 816. A flange 834 outwardly projects from back face 820 of arm 816. Fastener 808 rotatably secures flange 834 to boundary 30C (FIG. 21) so that when cable 827 mounted to arm 816, as discussed above, is pulled, cable mount 812 and first spindle 804 both pivot or rotate about rotational axis 814. An opposing second end of cable 827 typically extends to a lever that can be manually or mechanically pulled to rotate first spindle 804 as desired.

As discussed further below, first spindle 804 also includes a stem 836 outwardly projecting from terminal end face 838 of first spindle body 805. Stem 836 can project parallel to rotational axis 814 but is radially spaced apart from rotational axis 814. A second spindle 840 is disposed within secondary chamber 38 and engages with stem 836. Specifically, second spindle 840 includes a second spindle body 842 having a first end rotatably coupled to boundary 30C and an opposing second end that centrally passes through blocking plate 800 and is rotatably secured to regulating plate 780. Second spindle 840 rotates about a rotational axis 846 that is typically perpendicular to rotational axis 814. Second spindle 840/second spindle body 842 is secured to blocking plate 800 so that rotation of second spindle 840/second spindle body 842 facilitates rotation of blocking plate 800 between the open position and the closed position, as discussed above.

Second spindle 840 also includes a flange 847 radially outwardly projecting from second spindle body 842 having a notch 850 formed thereon. Stem 836 of first spindle 804 is received within notch 850. As a result, rotation of first spindle 804 about rotational axis 814 over a narrow angle range causes stem 836 to pivot flange 847/second spindle 840 about rotational axis 846 so as to move blocking plate 800 between the open position and the closed position. A spring 852, such as a coiled spring, encircles second spindle 840/second spindle body 842 and has opposing outwardly projecting ends 854 and 856. Spring end 854 biases against a stop 858 outwardly projecting from regulating plate 780 while spring end 856 biases against a stop 860 projecting from flange 847. Accordingly, as cable mount 812 is rotated by pulling on cable 827, second spindle 840 is rotated to the second position which causes blocking plate 800 to extend over and block fluid passages 786. Concurrently, spring 852 is resiliently compressed between stops 858 and 860, i.e., spring ends 854 and 856 are brought together which tensions spring 852. As such, when cable 827 is released, spring 852 resiliently returns blocking plate 800 back to the open position and returns cable 827 and cable mount 812 back to the original position.

Damper 10C is in the compression mode when blocking plate 800 is in the open position and damper 10C is in the spring mode when blocking plate 800 is in the closed position. Given the foregoing and with reference to FIGS. 22 and 26-28, as piston rod assembly 126C is moved distally along a compression stroke, the hydraulic fluid flows from primary chamber 36, through first fluid passage 742, through control passage 765 of control plate 756, and through second fluid passage 744. If blocking plate 800 is in the open position, i.e., damper 10C is in the compression mode, the hydraulic fluid can pass through unconstrained fluid passages 786 of regulating plate 780. The hydraulic fluid then moves floating piston 250 distally so as to compress the gas within distal secondary compartment 266. Having damper 10C in the compression mode allows for maximum displacement of piston rod assembly 126C and minimal damping. In contrast, if blocking plate 800 is in the closed position, i.e., damper 10C is in the sprint mode, the hydraulic fluid is forced to pass through regulating passages 788 of regulating plate 780 by distally flexing shim assembly 790. The required fluid pressure needed to flex shim assembly 790 limits or restricts the ability of piston rod assembly 126C to move distally along the compression stroke, thereby increasing damping of damper 10C. Further refinement of the damping in either the sprint mode or the compression mode can be adjusted by rotating orifice plate so that different sizes of orifices 374 are aligned with control passage 765. As piston rod assembly 126C is moved proximally along a rebound stroke, the hydraulic fluid flows in the opposite direction. However, shim assembly 790 prevents the hydraulic fluid from flowing proximally through regulating passages 788. Rather, in either the sprint mode or the compression mode, the hydraulic fluid is forced to flow proximally through fluid passages 786. When in the sprint mode during a rebound stroke, the hydraulic fluid is required by proximally flex blocking plate 800 to enable the hydraulic fluid to pass through fluid passages 786.

In view of the foregoing, applicant submits that the damping produced by damper 10C when in the compression mode and the sprint mode occurs in substantially the same way and has substantially the same results as previously discussed in more detail with regard to damper 10B. It is also appreciated that bypass channel 46 and compression metering needle 740 function in damper 10C, as previously discussed, when damper 10C is both in the compression mode and the sprint mode to help facilitate low speed damping.

It is also appreciated that various components of dampers 10, 10A, 10B, and 10C can be eliminated and that different combinations of the different components can be used. For example, in one embodiment stem 60 and compression metering needle 70 can be eliminated along with transfer passage 50, inlet passage 56, and check valve 84. In this embodiment, floating piston 250 in damper 10 can comprise a solid disk (as opposed to having an opening extending therethrough), such as is shown in FIG. 9. In addition to eliminating the forgoing, boundary 30 and regulating needle 114 can be eliminated from damper 10. In this embodiment, floating piston 250 would be openly exposed to piston rod assembly 126. In still another embodiment, inner sidewall 44 and bypass channel 46 can be eliminated. In this case, main piston 158 can extend to and slidably seal against the interior surface of outer sidewall 42. Examples of some of the foregoing configurations are disclosed in U.S. Pat. No. 6,978,872, which was previously incorporated herein by specific reference. The dampers disclosed herein can also have other configurations and/or incorporate features as disclosed in U.S. Pat. No. 6,978,872, which was previously incorporated herein by specific reference.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative assemblies, processes, products, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

1. A suspension damper comprising:
a housing bounding a primary chamber;
a main piston disposed within the primary chamber of the housing, the main piston having a first side and an opposing second side with a compression port extending therebetween;
hydraulic fluid disposed within the primary chamber;
a control valve assembly disposed within the primary chamber adjacent to the main piston, the control valve assembly comprising:
a valve guide; and
a control valve with at least one of the valve guide or the control valve at least partially encircling the other so that a valve compartment is at least partially formed between the valve guide and the control valve, the valve compartment being sealed from the hydraulic fluid with a gas being disposed within the valve compartment, the control valve assembly being movable between a first position wherein the valve compartment is compressed to a first volume and the control valve positioned toward the main piston so as to restrict the passage of the hydraulic fluid through the compression port and a second position wherein the valve compartment is expanded to a second volume larger than the first volume and the control valve is moved away from the main piston so that the hydraulic fluid can more freely flow through the compression port; and
a regulating spring extending between the main piston and the control valve, the regulating spring applying a resilient urging force against the control valve.

2. The suspension damper as recited in claim 1, wherein the regulating spring is at least partially compressed between the main position and the control valve.

3. The suspension damper as recited in claim 1, wherein the regulating spring is a coiled spring that encircles the control valve.

4. The suspension damper as recited in claim 1, further comprising a piston rod having a first end slidably disposed within the primary chamber of the housing and an opposing second end disposed outside of the primary chamber, the piston rod being selectively movable between an advanced position wherein a portion of the piston rod is advanced into the primary chamber causing the fluid pressure of the hydraulic fluid to increase and a retracted position wherein the portion of the piston rod is retracted from the primary chamber causing the fluid pressure of the hydraulic fluid to decrease, a portion of the hydraulic fluid passing through the compression port of the main piston as the piston rod is moved between the retracted position and the advanced position.

5. The suspension damper as recited in claim 4, wherein while the piston rod is stationary within the primary chamber, the control valve assembly is disposed in the first position and while the piston rod is being moved from the retracted position to the advanced position, the regulating spring assists in urging the control valve assembly into the second position.

6. The suspension damper as recited in claim 4, wherein increasing the fluid pressure of the hydraulic fluid within the primary chamber by moving the piston rod from the retracted position to the advanced position acts to move the control valve assembly toward the first position.

7. The suspension damper as recited in claim 4, wherein the main piston and the control valve are disposed on the piston rod.

8. The suspension damper as recited in claim 4, further comprising wherein the housing comprises:
an inner sidewall that encircles the primary chamber;
an outer wall that encircles the inner wall so that a bypass channel is disposed between the inner sidewall and the outer sidewall; and
a plurality of ports being longitudinally spaced apart along the inner sidewall and extending through the inner sidewall so as to provide fluid communication between the primary chamber and the bypass channel.

9. The suspension damper as recited in claim 8, further comprising:
the housing also bounding a secondary chamber;
a boundary at least partially bounding the primary chamber and the secondary chamber, the boundary bounding a transfer passage that extends at least partially between the primary chamber and the bypass channel; and
a check valve that controls fluid flow along the transfer passage.

10. A suspension damper comprising:
a housing bounding a primary chamber and a secondary chamber, the housing including:
an inner sidewall that encircles the primary chamber;
an outer sidewall that encircles the inner sidewall so that a bypass channel is disposed between the inner sidewall and the outer sidewall;
a plurality of ports being longitudinally spaced apart along the inner sidewall and extending through the inner sidewall so as to provide fluid communication between the primary chamber and the bypass channel;
a boundary at least partially bounding the primary chamber and the secondary chamber,
a main piston disposed within the primary chamber of the housing, the main piston having a first side and an opposing second side with a compression port extending therebetween;
hydraulic fluid disposed within the primary chamber; and
a control valve assembly disposed within the primary chamber adjacent to the main piston, the control valve assembly comprising:
a valve guide; and
a control valve with at least one of the valve guide or the control valve at least partially encircling the other so that a valve compartment is at least partially formed between the valve guide and the control valve, the valve compartment being sealed from the hydraulic fluid with a gas being disposed within the valve compartment, the control valve assembly being movable between a first position wherein the valve compartment is compressed to a first volume and the control valve positioned toward the main piston so as to restrict the passage of the hydraulic fluid through the compression port and a second position wherein the valve compartment is expanded to a second volume larger than the first volume and the control valve is moved away from the main piston so that the hydraulic fluid can more freely flow through the compression port.

11. The suspension damper as recited in claim 10, further comprising:
the boundary bounding a transfer passage that extends at least partially between the primary chamber and the bypass channel; and
a check valve that controls fluid flow along the transfer passage, wherein the check valve is disposed on the boundary.

12. The suspension damper as recited in claim 11, further comprising a compression metering needle being adjustable to selectively control fluid flow through the transfer passage.

13. The suspension damper as recited in claim 11, further comprising a piston rod having a first end slidably disposed within the primary chamber of the housing and an opposing second end disposed outside of the primary chamber, the piston rod being selectively movable between an advanced position wherein a portion of the piston rod is advanced into the primary chamber causing a fluid pressure of the hydraulic fluid to increase and a retracted position wherein the portion of the piston rod is retracted from the primary chamber causing the fluid pressure of the hydraulic fluid to decrease, a portion of the hydraulic fluid passing through the compression port of the main piston as the piston rod is moved between the retracted position and the advanced position.

14. The suspension damper as recited in claim 13, wherein when the piston rod is moved from the retracted position to the advanced position, the check valve is moved to an open position allowing the hydraulic fluid to flow from the primary chamber, through the transfer passage, and into the bypass channel and when the piston rod is moved from the advanced position to the retracted position, the check valve is moved to a closed position so as to preclude or restrict the flow of hydraulic fluid from bypass channel, through the transfer passage, and into the primary chamber.

15. The suspension damper as recited in claim 10, further comprising:
a pressure control passage passing through the boundary and providing fluid communication between the primary chamber and the secondary chamber; and
a regulating needle projecting into the pressure control passage, a position of the regulating needle being adjustable to selectively control fluid flow through the pressure control passage.

16. The suspension damper as recited in claim 10, further comprising a regulating spring extending between the main piston and the control valve, the regulating spring applying a resilient urging force against the control valve.

17. A suspension damper comprising:
a housing bounding a primary chamber and a spaced apart secondary chamber;
a main piston disposed within the primary chamber of the housing, the main piston having a first side and an opposing second side with a compression port extending therebetween;
hydraulic fluid disposed within the primary chamber;
a boundary at least partially bounding the primary chamber and the secondary chamber, the boundary bounding a pressure control passage passing through the boundary and providing fluid communication between the primary chamber and the secondary chamber, the pressure control passage being free of any check vales that would restrict flow of the hydraulic fluid between the primary chamber and the secondary chamber;
a regulating needle projecting into the pressure control passage, a position of the regulating needle being adjustable to selectively control fluid flow through the pressure control passage; and
a control valve assembly disposed within the primary chamber adjacent to the main piston, the control valve assembly comprising:
a valve guide; and
a control valve with at least one of the valve guide or the control valve at least partially encircling the other so that a valve compartment is at least partially formed between the valve guide and the control valve, the valve compartment being sealed from the hydraulic fluid with a gas being disposed within the valve compartment, the control valve assembly being movable between a first position wherein the valve compartment is compressed to a first volume and the control valve positioned toward the main piston so as to restrict the passage of the hydraulic fluid through the compression port and a second position wherein the valve compartment is expanded to a second volume larger than the first volume and the control valve is moved away from the main piston so that the hydraulic fluid can more freely flow through the compression port.

18. The suspension damper as recited in claim 17, wherein the pressure control passage has a first end with a first opening thereat that communicates with the primary chamber and an opposing second end with a second opening thereat that communicates with the secondary chamber, wherein the first opening and the second opening are freely and openly exposed to the primary chamber and the secondary chamber, respectively, so as to not be covered or coupled with a check valve.

19. The suspension damper as recited in claim 17, further comprising a floating piston movably disposed within the secondary chamber.

20. A suspension damper comprising:
a housing bounding a primary chamber disposed at a proximal end and a spaced apart secondary chamber disposed at a distal end;
a main piston disposed within the primary chamber of the housing, the main piston having a first side and an opposing second side with a compression port extending therebetween;
hydraulic fluid disposed within the primary chamber;
a boundary at least partially bounding the primary chamber and the secondary chamber, the boundary bounding a fluid passage extending through the boundary and providing fluid communication between the primary chamber and the secondary chamber;
a control plate disposed within the secondary chamber so as to laterally extend across the secondary chamber distal of the boundary or disposed within the boundary so as to laterally extend across the fluid passage, a control passage extending through the control plate; and
an orifice plate having a plurality of different sized orifices extending therethrough, the orifice plate being rotatably mounted adjacent to the control plate such that rotation of the orifice plate relative to the control plate causes each of the different sized orifices to consecutively align with the control passage.

21. The suspension damper as recited in claim 20, further comprising:
a regulating plate fixed within the secondary chamber distal of the control plate and having a proximal side face and an opposing distal side face, the regulating plate laterally extending across the secondary chamber with a fluid passage and a spaced apart first regulating passage each extending through regulating plate between the proximal side face and the distal side face;
a blocking plate mounted on the proximal side face of the regulating plate and being rotatable between a first position wherein the blocking plate is spaced apart from the fluid passage so that fluid can freely flow therethrough and a second position wherein the blocking plate covers the fluid passage so as to restrict the flow of fluid therethrough; and
a flexible shim mounted on the distal side face of the regulating plate, the flexible shim covering the first regulating passage and being spaced apart from the fluid passage.

22. The suspension damper as recited in claim 21, further comprising:
a rotatable regulating shaft being coupled with the blocking plate, the regulating shaft being tubular so as to bound a passage extending along a length thereof, and
a rotatable control shaft being coupled with the orifice plate, at least a portion of the control shaft being disposed within the passage of the regulating shaft.

23. The suspension damper as recited in claim 22, further comprising floating piston disposed within secondary chamber distal of the regulating plate, the floating piston encircling a portion of the regulating shaft and the control shaft.

24. The suspension damper as recited in claim 22, further comprising a control valve assembly disposed within the primary chamber adjacent to the main piston, the control valve assembly comprising:
a valve guide; and
a control valve with at least one of the valve guide or the control valve at least partially encircling the other so that a valve compartment is at least partially formed between the valve guide and the control valve, the valve compartment being sealed from the hydraulic fluid with a gas being disposed within the valve compartment, the control valve assembly being movable between a first position wherein the valve compartment is compressed to a first volume and the control valve positioned toward the main piston so as to restrict the passage of the hydraulic fluid through the compression port and a second position wherein the valve compartment is expanded to a second volume larger than the first volume and the control valve is moved away from the main piston so that the hydraulic fluid can more freely flow through the compression port.

25. A suspension damper comprising:
a housing bounding a primary chamber disposed at a proximal end and a spaced apart secondary chamber disposed at a distal end;
a main piston disposed within the primary chamber of the housing, the main piston having a first side and an opposing second side with a compression port extending therebetween;
hydraulic fluid disposed within the primary chamber;
a boundary at least partially bounding the primary chamber and the secondary chamber, the boundary bounding a passage extending through the boundary and providing fluid communication between the primary chamber and the secondary chamber;
a regulating plate fixed within the secondary chamber and having a proximal side face and an opposing distal side face, the regulating plate laterally extending across the secondary chamber with a fluid passage and a spaced apart first regulating passage each extending through regulating plate between the proximal side face and the distal side face;
a blocking plate mounted on the proximal side face of the regulating plate and being rotatable between a first position wherein the blocking plate is spaced apart from the fluid passage so that fluid can freely flow therethrough and a second position wherein the blocking plate covers the fluid passage so as to restrict the flow of fluid therethrough; and
a flexible shim mounted on the distal side face of the regulating plate, the flexible shim covering the first regulating passage and being spaced apart from the fluid passage.

26. The suspension damper as recited in claim 25, further comprising:
the distal side face comprising a distal lower face and a distal raised face wherein the distal raised face is outwardly spaced apart from distal lower face;
the fluid passage extending through the distal lower face and being spaced apart from the distal raised face;
the first regulating passage extending through the distal raised face; and
the flexible shim being disposed adjacent to the distal raised face so as to cover the first regulating passage.

27. The suspension damper as recited in claim 25, further comprising:
a control plate fixed within the secondary chamber so as to laterally extend across the secondary chamber distal of the boundary and proximal of the regulating plate, a control passage extending through the control plate; and
an orifice plate having a plurality of different sized orifices extending therethrough, the orifice plate being rotatably mounted adjacent to the control plate such that rotation of the orifice plate relative to the control plate causes each of the different sized orifices to consecutively align with the control passage.

28. The suspension damper as recited in claim 27, further comprising:
a rotatable regulating shaft being coupled with the blocking plate, the regulating shaft being tubular so as to bound a passage extending along a length thereof; and
a rotatable control shaft being coupled with the orifice plate, at least a portion of the control shaft being disposed within the passage of the regulating shaft.

29. The suspension damper as recited in claim 28, further comprising floating piston disposed within secondary chamber distal of the regulating plate, the floating piston encircling a portion of the regulating shaft and the control shaft.

30. The suspension damper as recited in claim 28, further comprising:
the control shaft being tubular and bounding a passage extending along a length thereof; and
a compression metering needle being rotatably disposed within the passage of the control shaft and interacting with the boundary.

31. The suspension damper as recited in claim 30, further comprising:
a tubular outer shaft encircling the rotatable regulating shaft; and
a floating piston disposed within secondary chamber distal of the regulating plate, the floating piston encircling a portion of the outer shaft, the regulating shaft, the control shaft, and the compression metering needle and being slidable along the outer shaft.

32. A suspension damper comprising:
a housing bounding a primary chamber disposed at a proximal end and a spaced apart secondary chamber disposed at a distal end, the housing including an end wall disposed at the distal end;
a main piston disposed within the primary chamber of the housing, the main piston having a first side and an opposing second side with a compression port extending therebetween;
hydraulic fluid disposed within the primary chamber;
a boundary at least partially bounding the primary chamber and the secondary chamber, the boundary bounding a passage extending through the boundary and providing fluid communication between the primary chamber and the secondary chamber; and
a floating piston movably disposed within the secondary chamber;
wherein the end wall of the housing comprises:
an interior face facing the secondary chamber, an opposing exterior face, and an outer side face extending therebetween;
a first inlet recessed into the exterior face;
an annular tapered notch recessed into the outer side face of the end wall so as to encircle the end wall, the tapered notch being in fluid communication with the secondary chamber;
a first gas passage extending from the first inlet to the tapered notch; and
an elastomeric ring received within and urging against the tapered notch so as to seal the first gas passage closed thereat.

33. The suspension damper as recited in claim 32, further comprising:
second inlet recessed into the exterior face of the end wall and terminating at a tapered floor;
a second gas passage extending from the tapered floor to the interior face of the end wall, the second gas passage communicating with the secondary chamber;
a set screw disposed within second inlet; and
a ball disposed between the set screw and the tapered floor.
